(19) United States
(12) Patent Application Publication
(10) Pub. No.: US 2026/0023480 A1
(43) Pub. Date: Jan. 22, 2026

(54) ELECTRONIC DEVICE FOR CONTROLLING DISPLAY OF EXECUTION SCREENS, OPERATION METHOD THEREOF, AND RECORDING MEDIUM

(71) Applicant: Samsung Electronics Co., Ltd., Suwon-si (KR)

(72) Inventors: Ilku CHANG, Suwon-si (KR); Seungwook NAM, Suwon-si (KR); Hyunjung KIM, Suwon-si (KR); Kyungwha HONG, Suwon-si (KR)

(21) Appl. No.: 19/347,092

(22) Filed: Oct. 1, 2025

Related U.S. Application Data
(63) Continuation of application No. PCT/KR2024/095190, filed on Feb. 15, 2024.

(30) Foreign Application Priority Data
Apr. 3, 2023 (KR) 10-2023-0043719
Jul. 14, 2023 (KR) 10-2023-0091635

(51) Int. Cl. G06F 3/04886; G06F 3/04842; G06F 3/04845; G06F 3/04883

(52) U.S. Cl. CPC G06F 3/04886; G06F 3/04842; G06F 3/04845; G06F 3/04883; G06F 2203/04803

(57) ABSTRACT

An electronic device comprises: a memory storing instructions, a touch screen, and at least one processor, comprising processing circuitry, configured to execute the instructions and to cause the electronic device to: display a first execution screen of a first application on the touch screen; display a second execution screen of a second application and a portion of the first execution screen on the touch screen when a first input to a first object included in the first execution screen and representing the second application is confirmed, wherein a second object for adjusting the display areas of the first execution screen and the second execution screen is displayed on the second execution screen or the portion of the first execution screen; confirm a second input to the second object via the touch screen; and display the first execution screen, the second execution screen, or the portion of the first execution screen and a portion of the second execution screen on the basis of the travel distance and travel direction of the second object due to the second input.

### CROSS-REFERENCE TO RELATED APPLICATIONS

This application is a continuation of International Application No. PCT/KR2024/095190 designating the United States, filed on Feb. 15, 2024, in the Korean Intellectual Property Receiving Office and claiming priority to Korean Patent Application Nos. 10-2023-0043719, filed on Apr. 3, 2023, and 10-2023-0091635, filed on Jul. 14, 2023, in the Korean Intellectual Property Office, the disclosures of each of which are incorporated by reference herein in their entireties.

### BACKGROUND

### Field

The disclosure relates to an electronic device controlling the display of execution screens, a method for operating the same, and a storage medium.

### Description of Related Art

Recently, with the rapid increase in demand for smartphones and tablets, research on user interface methods related to touchscreens provided in these devices may be actively conducted. Research is being conducted specifically to enable smartphones or tablets to offer nearly intuitive interface methods related to user experience. Consequently, interface methods that align with user intuition in various ways are being disclosed.

Most smartphones and tablets are equipped with touchscreens, and consequently, recent research on interface methods aims to develop a way for users to manipulate these touchscreens more easily and accurately.

Conventional electronic devices, when executing an application and subsequently executing another application, must interrupt the display of the execution screen of the application and display the execution screen of the other application. Furthermore, during the multitasking of multiple applications, the user may need to continuously perform screen switching operations between applications, leading to inconvenience, and have difficulties in easily understanding the results of the progress between applications.

### SUMMARY

According to an example embodiment, an electronic device may comprise memory storing instructions, a touchscreen, and at least one processor comprising processing circuitry.

In the electronic device according to an example embodiment, at least one processor, individually and/or collectively, may be configured to execute the instructions and to cause the electronic device to display a first execution screen of a first application on the touchscreen.

In the electronic device according to an example embodiment, at least one processor, individually and/or collectively, may be configured to cause the electronic device to based on identifying a first input on a first object representing a second application included in the first execution screen, display a second execution screen of the second application and a portion of the first execution screen on the touchscreen.

In the electronic device according to an example embodiment, a second object for adjusting a display area of the first execution screen and the second execution screen may be displayed on the portion of the first execution screen or the second execution screen.

In the electronic device according to an example embodiment, at least one processor, individually and/or collectively, may be configured to cause the electronic device to identify a second input on the second object through the touchscreen.

In the electronic device according to an example embodiment, at least one processor, individually and/or collectively, may be configured to cause the electronic device to, based on a movement distance and movement direction of the second object according to the second input, display the first execution screen, the second execution screen, or a portion of the first execution screen and a portion of the second execution screen.

According to an example embodiment, a method for operating an electronic device may comprise displaying a first execution screen of a first application on a touchscreen of the electronic device.

According to an example embodiment, the method for operating the electronic device may comprise, based on identifying an input on a first object representing a second application included in the first execution screen, displaying a second execution screen of the second application and a portion of the first execution screen on the touchscreen.

According to an example embodiment, in the method for operating the electronic device, a second object for adjusting a display area of the first execution screen and the second execution screen may be displayed on the portion of the first execution screen or the second execution screen.

According to an example embodiment, the method for operating the electronic device may comprise identifying an input on the second object through the touchscreen.

According to an example embodiment, the method for operating the electronic device may comprise, based on a movement distance and movement direction of the second object according to the second input, displaying the first execution screen, the second execution screen, or a portion of the first execution screen and a portion of the second execution screen.

According to an example embodiment, a non-transitory computer-readable storage medium may store at least one instruction which, when executed by at least one processor, comprising processing circuitry, individually and/or collectively, of an electronic device, cause the electronic device to perform operations comprising displaying a first execution screen of a first application on a touchscreen of an electronic device.

According to an example embodiment, the non-transitory computer-readable recording medium may store at least one instruction which, when executed by at least one processor, comprising processing circuitry, individually and/or collectively, of an electronic device, cause the electronic device to perform operations comprising, based on identifying an input on a first object representing a second application included in the first execution screen, displaying a second execution screen of the second application and a portion of the first execution screen on the touchscreen.

According to an example embodiment, in the non-transitory computer-readable storage medium may store at least one instruction which, when executed by at least one processor, comprising processing circuitry, individually and/or collectively, of an electronic device, cause the electronic device to perform operations comprising, displaying a second object for adjusting a display area of the first execution screen and the second execution screen may be displayed on the portion of the first execution screen or the second execution screen.

According to an example embodiment, the non-transitory computer-readable recording medium may store at least one instruction which, when executed by at least one processor, comprising processing circuitry, individually and/or collectively, of an electronic device, cause the electronic device to perform operations comprising identifying an input on the second object through the touchscreen.

According to an example embodiment, the non-transitory computer-readable recording medium may store at least one instruction which, when executed by at least one processor, comprising processing circuitry, individually and/or collectively, of an electronic device, cause the electronic device to perform operations comprising, based on a movement distance and movement direction of the second object according to the second input, displaying the first execution screen, the second execution screen, or a portion of the first execution screen and a portion of the second execution screen.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example electronic device in a network environment according to various embodiments;

FIGS. 2A, 2B and 2C are diagrams illustrating an example operation in which an electronic device displays a portion of a first execution screen and a portion of a second execution screen as split screens, according to various embodiments;

FIG. 3 is a block diagram illustrating an example configuration of an electronic device according to various embodiments;

FIG. 4 is a flowchart illustrating an example operation in which an electronic device displays a first execution screen and a second execution screen, according to various embodiments;

FIG. 5 is a flowchart illustrating an example operation in which an electronic device adjusts a display area of a screen displayed on a touchscreen based on a movement distance and a movement direction of a second object according to various embodiments;

FIG. 6 is a flowchart illustrating an example operation in which an electronic device adjusts a display area of a screen displayed on a touchscreen based on a movement distance and a movement direction of a second object according to various embodiments;

FIG. 7A is a flowchart illustrating an example operation in which an electronic device displays a first execution screen based on a third input, according to various embodiments;

FIG. 7B is a flowchart illustrating an example operation in which an electronic device displays a second execution screen based on a movement direction of a second object, according to various embodiments;

FIG. 8A is a diagram illustrating an example operation in which an electronic device displays a second execution screen based on an input on a first object included in a first execution screen according to various embodiments;

FIGS. 8B, 8C, 8D, and 8E are diagrams illustrating an example operation in which an electronic device displays a second object on a first execution screen and/or a second execution screen according to various embodiments;

FIGS. 9A and 9B are diagrams illustrating an example operation in which an electronic device adjusts a display area of a screen displayed on a touchscreen based on a movement distance and a movement direction of a second object, according to various embodiments;

FIGS. 10A, 10B, 10C and 10D are diagrams illustrating an example operation in which an electronic device displays a first execution screen based on a movement distance and a movement direction of a second object, according to various embodiments;

FIG. 11A is a diagram illustrating an example operation in which an electronic device displays a second execution screen based on a movement direction of a second object, according to various embodiments;

FIG. 11B is a diagram illustrating an example operation in which an electronic device displays a second execution screen based on a movement direction of a second object, according to various embodiments;

FIGS. 12A, 12B and 12C are diagrams illustrating an example operation in which an electronic device adjusts a display area of a screen displayed on a touchscreen according to various embodiments;

FIG. 13A is a diagrams illustrating a second execution screen of a second application according to various embodiments;

FIGS. 13B and 13C are diagrams illustrating a third execution screen of a third application according to various embodiments;

FIG. 14A is a diagram illustrating a first execution screen of a first application according to various embodiments;

FIG. 14B is a diagram illustrating an example operation in which an electronic device displays an execution screen of at least one application based on an input on a first execution screen according to various embodiments;

FIG. 14C is a diagram illustrating an example operation in which an electronic device displays an execution screen of at least one application based on an input on a first execution screen according to various embodiments;

FIG. 14D is a diagram illustrating a home screen of an electronic device according to various embodiments;

FIGS. 15A, 15B and 15C are diagrams illustrating an example operation in which an electronic device adjusts a display area of a screen displayed on a touchscreen according to various embodiments; and

FIGS. 16A, 16B and 16C are diagrams illustrating an example operation in which an electronic device adjusts a display area of a screen displayed on a touchscreen according to various embodiments.

### DETAILED DESCRIPTION

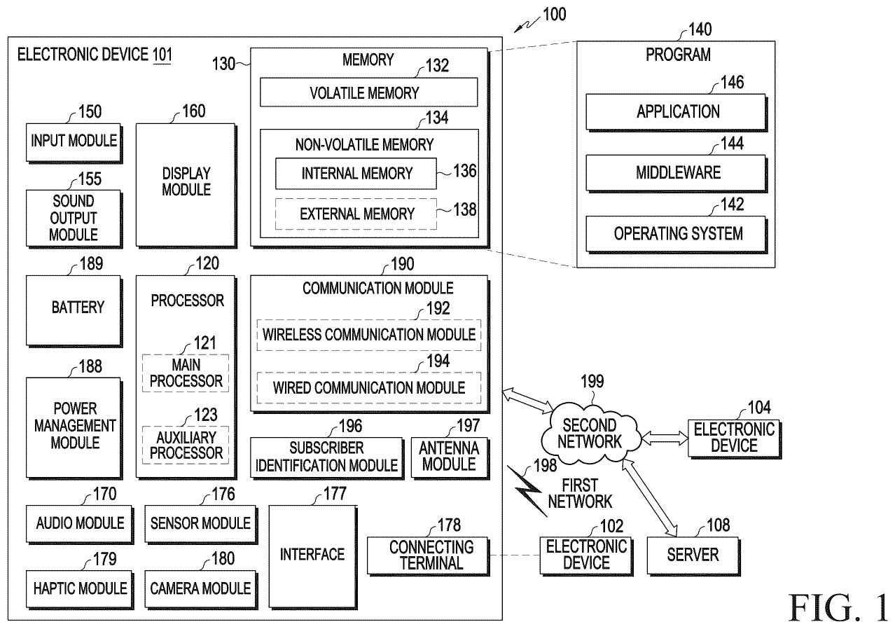

FIG. 1 is a block diagram illustrating an example electronic device 101 in a network environment 100 according to various embodiments. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

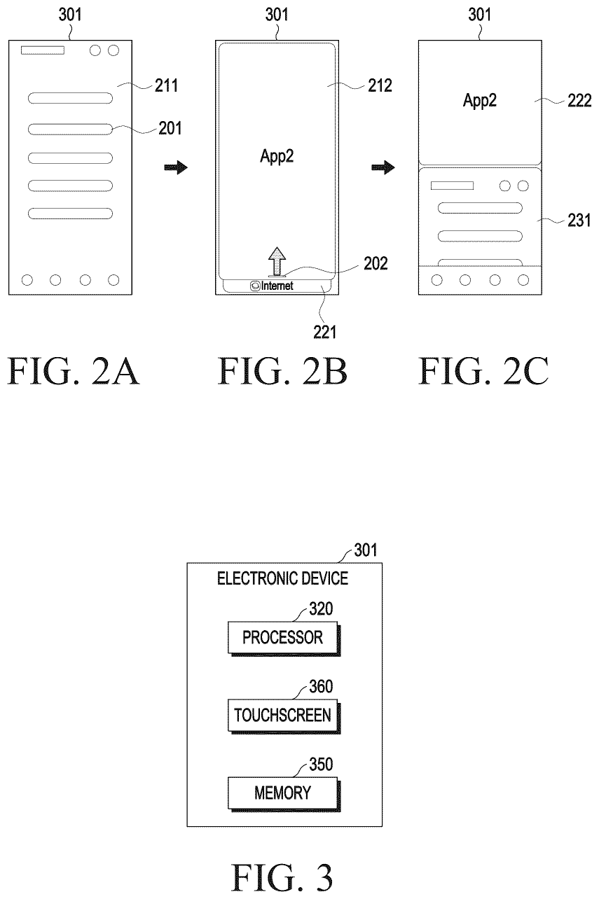

FIGS. 2A, 2B and 2C are diagrams illustrating an example operation in which an electronic device displays a portion of a first execution screen and a portion of a second execution screen as split screens, according to various embodiments.

According to an embodiment, the electronic device 301 may execute a first application. According to an embodiment, the electronic device 301 may display a first execution screen of the first application. According to an embodiment, the electronic device 301 may execute a second application while the first application is being executed. According to an embodiment, the electronic device 301 may display at least a portion of the first execution screen of the first application and at least a portion of the second execution screen of the second application together. According to an embodiment, the electronic device 301 may display a portion 231 of the first execution screen of the first application and a portion 222 of the second execution screen of the second application in a multi-window.

Referring to FIG. 2A, according to an embodiment, the electronic device 301 may display the first execution screen 211 on the touchscreen (360 of FIG. 3) based on the execution of the first application. According to an embodiment, the first execution screen 211 may include the first object 201 representing the second application. For example, the first object 201 may include an icon for executing the second application or an object (e.g., text or icon) linked to the second application. If the user input (e.g., a touch input or a tap input) on the first object 201 is identified, the electronic device 301 may execute the second application.

Referring to FIG. 2B, according to an embodiment, the electronic device 301 may display a portion 221 of the first execution screen and the second execution screen 212 based on a first input on the first object 201. According to an embodiment, the electronic device 301 may display the second execution screen 212 on the first execution screen 211. According to an embodiment, the first input may include, for example, and without limitation, a touch input or a tap input on the first object 201. According to an embodiment, the second execution screen 212 may include a second object 202. According to an embodiment, the second object 202 may refer, for example, to an object (e.g., a handler) for adjusting the display area of the first execution screen 211 and the second execution screen 212. For example, if the user input (e.g., a drag input or a swipe input) on the second object 202 is identified, the electronic device 301 may move the second object 202. In this case, the electronic device 301 may control (e.g., increase or decrease) the size of the second execution screen of the second application and the display area of the execution screen of the first application according to the movement of the second object 202.

According to an embodiment, if a second input on the second object 202 is identified, the electronic device 301 may identify the movement distance and movement direction of the second object 202. According to an embodiment, the movement direction of the second object 202 may refer, for example, to an up, down, left, and right direction (e.g., a direction from bottom to top). According to an embodiment, the second input may refer, for example, to a swipe input or a drag input on the second object 202. According to an embodiment, the electronic device 301 may identify whether the movement distance of the second object 202 is larger than a designated first distance. For example, the designated first distance may be a reference distance predesignated for displaying the first execution screen and the second execution screen in the multi-window mode.

Referring to FIG. 2C, according to an embodiment, if it is identified that the movement distance of the second object 202 is larger than the designated first distance, the electronic device 301 may display a portion 231 of the first execution screen and a portion 222 of the second execution screen together on the touchscreen 360. For example, the portion 231 of the first execution screen may be larger than the portion 221 of the first execution screen. The portion 222 of the second execution screen may be smaller than the second execution screen 212. According to an embodiment, the electronic device 301 may display the portion 231 of the first execution screen in the lower area of the touchscreen 360 and the portion 222 of the second execution screen in the upper area of the touchscreen 360.

Conventionally, when displaying the first execution screen of the first application after displaying the second execution screen by executing the second application, the electronic device should terminate the display of the existing second execution screen and display the first execution screen. For this reason, the conventional electronic performs the operation of terminating the running existing application and the operation of re-executing the new application. In other words, the conventional electronic device performs a separate two-step operation as described above.

According to an embodiment, the electronic device 301 may display the second object 202 on the portion 221 of the first execution screen or the second execution screen 212. According to an embodiment, the electronic device 301 may display the portion 221 of the first execution screen and the second execution screen 212, display the first execution screen 211 or the second execution screen 212, or display the portion 231 of the first execution screen and the portion 222 of the second execution screen based on the movement distance and the movement direction of the second object 202. In other words, the electronic device 301 may provide the second object 202 for controlling the display of the execution screens 211, 212, 221, and 231. Accordingly, the electronic device 301 may control the display of the execution screens 211, 212, 221, and 231 using the second object 202 without performing the operation of terminating the running existing application and the operation of re-executing the new application.

FIG. 3 is a block diagram illustrating an example configuration of an electronic device according to various embodiments.

Referring to FIG. 3, according to an embodiment, the electronic device 301 may include a processor (e.g., including processing circuitry) 320, memory 350, and a touchscreen 360. The electronic device 301 may be implemented to be identical or similar to the electronic device 101 of FIG. 1. The memory 350 may be implemented to be identical or similar to the memory 130 of FIG. 1. The touchscreen 360 may be implemented to be identical or similar to the display module 160 of FIG. 1.

According to an embodiment, the processor 320 may include various processing circuitry and control the overall operation of the electronic device 301. For example, the processor 320 may be implemented to be the same as or similar to the processor 120 of FIG. 1. Further, the description of the processor 120 above is the same as or similar to the processor 320 and an overlapping description may not be repeated here.

According to an embodiment, a plurality of applications may be stored as software in the memory 350.

According to an embodiment, if an input for executing the first application is identified, the processor 320 may execute any one (e.g., a first application) of the plurality of applications stored in the memory 350. According to an embodiment, the processor 320 may display the first execution screen of the first application on the touchscreen 360. For example, the processor 320 may display the entire portion of the first execution screen in the display area of the touchscreen 360. For example, the display area of the touchscreen 360 may refer, for example, to an area set to display the execution screen of the application in the entire area of the touchscreen 360. For example, the display area of the touchscreen 360 may be set to be the same as or partially different from the entire area of the touchscreen 360. For example, the display area of the touchscreen 360 in which the execution screen of the application is displayed may be set to be the same or different for each application.

According to an embodiment, the processor 320 may identify a first input on a first object representing the second application included in the first execution screen. According to an embodiment, the first input may include, for example, and without limitation, a touch input or a tap input. However, this is an example, and the first input may include various types of inputs. According to an embodiment, if a first input on the first object is identified, the processor 320 may execute the second application stored in the memory 350. For example, the first object may include an icon of the second application or information linked to the second application (e.g., a uniform resource locator (URL) address).

According to an embodiment, the processor 320 may display the second execution screen and a portion of the first execution screen of the second application based on the first input on the first object. For example, the processor 320 may display the entire portion of the second execution screen in the display area of the touchscreen 360. According to an embodiment, the processor 320 may display the second execution screen on the first execution screen. According to an embodiment, the processor 320 may display a portion of the first execution screen in the display area of the touchscreen 360 so as not to overlap the second execution screen. According to an embodiment, a portion of the first execution screen may be displayed in the lower area or the upper area of the touchscreen 360. For example, a portion of the first execution screen may include the lower area of the first execution screen. For example, a portion of the first execution screen may include the upper area of the first execution screen. For example, a portion of the first execution screen may include the type of the first application (e.g., an application related to the Internet) or the name set in the first application.

According to an embodiment, when displaying the second execution screen (e.g., the entire portion of the second execution screen) and a portion of the first execution screen, the processor 320 may apply a visual effect to the second execution screen and/or a portion of the first execution screen. For example, the visual effect may include an effect indicating entry into a mode for controlling the display of two screens to the user. For example, the processor 320 may reduce the size of the second execution screen by a predetermined ratio while maintaining the aspect ratio of the second execution screen. The processor 320 may reduce the size of the first execution screen by a predetermined ratio while maintaining the aspect ratio of a portion of the first execution screen. For example, the processor 320 may apply a specific color to a portion of the outline of the display area of the touchscreen 360. Accordingly, the processor 320 may apply a visual effect (e.g., applying white or black to the outline portion) as if there is a margin in the outline portion of the display area of the touchscreen 360.

According to an embodiment, the processor 320 may identify the second input on the second object. According to an embodiment, the second object may refer, for example, to an object for controlling the display of the first execution screen and the second execution screen. For example, the second input may include, for example, and without limitation, a swipe input or a drag input on the second object. According to an embodiment, the second object may be displayed in the lower area or the upper area of the touchscreen 360. According to an embodiment, the processor 320 may display the second object on a portion of the first execution screen. According to an embodiment, the processor 320 may display the second object on the second execution screen. According to an embodiment, the processor 320 may display the second object on a boundary surface between a portion of the first execution screen and the second execution screen. According to an embodiment, the processor 320 may apply a visual effect to the second object based on the second input. For example, the visual effect on the second object may include an effect indicating that the second object moves to the user. For example, if the second input on the second object is identified, the processor 320 may adjust the transparency of the second object. According to an embodiment, the processor 320 may not display the second object before a designated time from the time when the second execution screen is displayed and, after the designated time, display the second object.

According to an embodiment, the processor 320 may identify a command for changing the screen displayed on the touchscreen 360 from the vertical mode to the horizontal mode according to the rotation of the electronic device 301. According to an embodiment, the processor 320 may display a portion of the first execution screen and the second execution screen as screens in the horizontal mode based on the command. According to an embodiment, as a portion of the first execution screen and the second execution screen are displayed as screens in the horizontal mode, the processor 320 may display the second object on the left or right side of the touchscreen 360. According to an embodiment, the movement direction of the second object based on the second input on the second object may refer, for example, to the direction in which the second object moves in the left and right directions. According to an embodiment, the processor 320 may display a portion of the first execution screen and a portion of the second execution screen on the left and right areas of the touchscreen 360 in the horizontal mode.

According to an embodiment, the processor 320 may identify the movement distance and the movement direction of the second object according to the second input on the second object. According to an embodiment, the processor 320 may display the first execution screen, the second execution screen, or a portion of the first execution screen and a portion of the second execution screen based on the movement distance and the movement direction of the second object. In this case, the processor 320 may not display the second object.

According to an embodiment, the processor 320 may identify whether the movement direction of the second input on the second object is the first direction. According to an embodiment, when the second object and a portion of the first execution screen are displayed in the lower area of the touchscreen 360, the first direction may refer, for example, to a direction from bottom to top. According to an embodiment, when the second object and a portion of the first execution screen are displayed in the upper area of the touchscreen 360, the first direction may refer, for example, to a direction from top to bottom.

According to an embodiment, the processor 320 may identify the movement distance of the second object based on the movement direction of the second input being identified as the first direction. According to an embodiment, the processor 320 may compare the movement distance of the second object with a designated first distance and/or a designated second distance. For example, the designated first distance may be a reference distance predesignated to display a portion of the first execution screen and a portion of the second execution screen in the multi-window mode. The designated second distance may be a reference distance predesignated to display only the entire portion of the first execution screen instead of the multi-window mode. According to an embodiment, the movement distance of the second object may refer. for example, to a distance by which the second object is moved based on the second input. For example, the designated second distance and the designated first distance may be automatically set by the processor 320 or may be set by the user. According to an embodiment, the processor 320 may differently set a visual effect (or a degree to which a visual effect is applied) applied to the second object according to the movement distance of the second object. For example, as the movement distance of the second object increases, the processor 320 may set the transparency of the second object to be higher or lower. For example, as the movement distance of the second object increases, the processor 320 may set the color of the second object to be displayed dark or light.

According to an embodiment, if it is identified that the movement distance of the second object is larger than the designated first distance and smaller than the designated second distance, the processor 320 may display a portion of the first execution screen and a portion of the second execution screen as split screens. In this case, the processor 320 may display the second object. The processor 320 may adjust the size of a portion of the first execution screen and a portion of the second execution screen according to an additional user input on the second object. According to the implementation, the processor 320 may not display the second object. According to an embodiment, the designated second distance may refer, for example, to a distance having a value larger than the designated first distance. According to an embodiment, the processor 320 may display a portion of the first execution screen and a portion of the second execution screen, as split screens, in the display area of the touchscreen 360. According to an embodiment, the processor 320 may display a portion of the second execution screen in the upper area of the touchscreen 360 and a portion of the first execution screen in the lower area of the touchscreen 360. According to an embodiment, the processor 320 may display a portion of the first execution screen in the upper area of the touchscreen 360 and a portion of the second execution screen in the lower area of the touchscreen 360. In this case, the processor 320 may not apply a visual effect of having a margin in a portion of the display area of the touchscreen 360 (e.g., an outline portion and/or a boundary portion between the first execution screen and the second execution screen).

According to an embodiment, the processor 320 may determine a first area in which a portion of the first execution screen is displayed and a second area in which a portion of the second execution screen is displayed. The first area and the second area may refer, for example, to portions of the display area of the touchscreen 360. According to an embodiment, the size of the first area and the size of the second area may be set to be the same. According to an embodiment, the size of the first area and the size of the second area may be set to be different from each other.

According to an embodiment, the processor 320 may display the upper area of the first execution screen in the upper area of the first area. The processor 320 may display a portion of the first execution screen corresponding to the size of the first area with respect to the upper area of the first execution screen. According to an embodiment, the processor 320 may display the lower area of the first execution screen in the lower area of the first area. The processor 320 may display a portion of the first execution screen corresponding to the size of the first area with respect to the lower area of the first execution screen. According to an embodiment, the processor 320 may display the upper area of the second execution screen in the upper area of the second area. The processor 320 may display a portion of the second execution screen corresponding to the size of the second area with respect to the upper area of the second execution screen. According to an embodiment, the processor 320 may display the lower area of the second execution screen in the lower area of the second area. The processor 320 may display a portion of the second execution screen corresponding to the size of the second area with respect to the lower area of the second execution screen. According to an embodiment, the processor 320 may determine the central area of the first execution screen as the upper or lower area of the first area. The processor 320 may display a portion of the first execution screen to correspond to the size of the first area with respect to a specific area of the first execution screen (e.g., a central area of the entire first execution screen). According to an embodiment, the processor 320 may determine the central area of the second execution screen as the upper or lower area of the second area. The processor 320 may display a portion of the second execution screen to correspond to the size of the second area with respect to a specific area of the second execution screen (e.g., a central area of the entire second execution screen). According to an embodiment, a portion of the first execution screen may include the first object. According to an embodiment, the processor 320 may display a portion of the first execution screen on which the first object is displayed as a portion of the first execution screen. In this case, the processor 320 may display the first object to be visually distinguished. For example, the processor 320 may apply a color to the first object to be visually distinguished. For example, the processor 320 may adjust the transparency of the first object or apply a specific color to the first object. However, this is an example, and a portion of the first execution screen corresponding to the size of the first area and a portion of the second execution screen corresponding to the size of the second area are not limited thereto.

According to an embodiment, if it is identified that the movement distance of the second object is not larger than the designated first distance, the processor 320 may maintain display of the second execution screen and a portion of the first execution screen. For example, if it is identified that the movement distance of the second object is not larger than the designated first distance, the processor 320 may display the second execution screen and a portion of the first execution screen as before.

According to an embodiment, if it is identified that the movement distance of the second object is larger than the second distance larger than the first designated distance, the processor 320 may display the first execution screen on the touchscreen 360. According to an embodiment, the processor 320 may display the entire portion of the first execution screen in the display area of the touchscreen 360. In this case, the processor 320 may not display the second execution screen. According to the implementation, the processor 320 may terminate the second application. According to an embodiment, the processor 320 may distinctly display the first object included in the first execution screen according to the movement of the second object according to the second input. According to an embodiment, the processor 320 may apply a visual effect to the first object. For example, the processor 320 may adjust the transparency of the first object or apply a color to the first object. According to an embodiment, if a tap input or a touch input is identified by the touchscreen 360, the processor 320 may release a visual effect applied to the first object.

According to an embodiment, the processor 320 may identify a third input on a portion of the first execution screen. According to an embodiment, the third input may include, for example, and without limitation, a tap input or a touch input. According to an embodiment, the processor 320 may display the first execution screen. According to an embodiment, the processor 320 may display the entire portion of the first execution screen in the display area of the touchscreen 360. In this case, the processor 320 may not display the second object.

According to an embodiment, the processor 320 may identify that the movement direction of the second input on the second object is the second direction. For example, the second direction may be a direction opposite to the first direction. According to an embodiment, when the second object and a portion of the first execution screen are displayed in the lower area of the touchscreen 360, the second direction may be a direction from top to bottom. According to an embodiment, when the second object and a portion of the first execution screen are displayed in the upper area of the touchscreen 360, the second direction may be a direction from bottom to top. According to an embodiment, the processor 320 may display the second execution screen. According to an embodiment, the processor 320 may display the entire portion of the second execution screen in the display area of the touchscreen 360. In this case, the electronic device 301 may not display a portion of the first execution screen.

According to an embodiment, the second execution screen may include a third object representing the third application. For example, the third object may include an icon of the third application or an object (e.g., text or icon) linked to the third application. According to an embodiment, the electronic device 301 may identify a fourth input on the third object. According to an embodiment, the fourth input may include, for example, and without limitation, a touch input or a tap input. However, this is an example, and the fourth input may include various types of inputs. According to an embodiment, if the fourth input on the third object is identified, the electronic device 301 may execute the third application stored in the memory 350.

According to an embodiment, the processor 320 may display a portion of the first execution screen, a portion of the second execution screen, and the third execution screen of the third application on the touchscreen 360. For example, a portion of the first execution screen may include the lower area or the upper area of the first execution screen. For example, a portion of the second execution screen may include the lower area or the upper area of the second execution screen. For example, a portion of the first execution screen may include at least a portion of the first execution screen, the type of the first application, the name set in the first application, keyword information about the first execution screen, or task information related to the first application. For example, a portion of the second execution screen may include at least a portion of the second execution screen, the type of the second application, the name set in the second application, keyword information about the second execution screen, or task information related to the second application. According to an embodiment, the processor 320 may display an object for displaying a portion of the first execution screen, a portion of the second execution screen, and a portion of the third execution screen as split screens on a portion of the first execution screen, a portion of the second execution screen, or a portion of the third execution screen. According to an embodiment, if the movement distance of the object for displaying a portion of the first execution screen, a portion of the second execution screen, and a portion of the third execution screen as split screens is larger than the designated first distance, and the movement direction is identified to be the first direction, the processor 320 may display a portion of the first execution screen, a portion of the second execution screen, and a portion of the third execution screen as split screens. The first direction may refer, for example, to a direction from bottom to top.

According to an embodiment, the processor 320 may display a portion of the second execution screen and the third execution screen of the third application. According to an embodiment, the processor 320 may display an object for displaying a portion of the second execution screen and a portion of the third execution screen as split screens on a portion of the second execution screen or a portion of the third execution screen. According to an embodiment, if the movement distance of the object for displaying a portion of the second execution screen and a portion of the third execution screen as split screens is larger than the designated first distance and the movement direction is identified to be the first direction, the processor 320 may display a portion of the second execution screen and a portion of the third execution screen as split screens.

The operations of the electronic device 301 described in the drawings may be performed by the processor 320. Further, it is described that the operations performed by the processor 320 are performed by the electronic device 301 or that the processor 320 is configured to cause the electronic device 301 to perform the various operations.

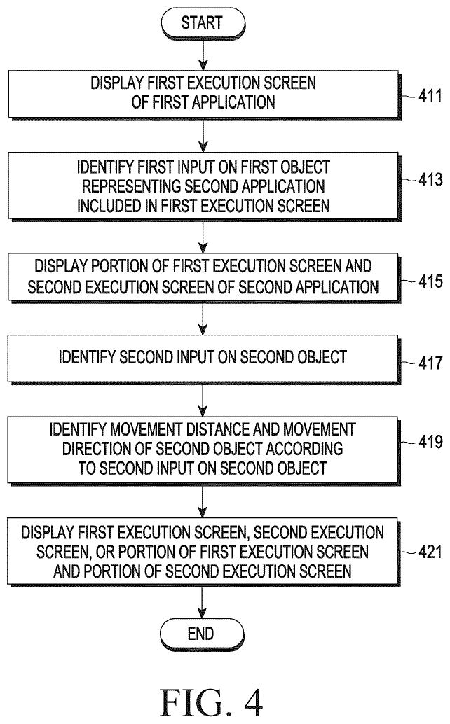

FIG. 4 is a flowchart illustrating an example operation in which an electronic device displays a first execution screen and a second execution screen, according to various embodiments.

Referring to FIG. 4, according to an embodiment, in operation 411, the electronic device 301 (e.g., the electronic device 301 of FIG. 3) may display the first execution screen of the first application on the touchscreen 360 (e.g., the touchscreen 360 of FIG. 3). For example, the electronic device 301 may display the entire portion of the first execution screen in the entire display area of the touchscreen 360. For example, the display area of the touchscreen 360 may refer, for example, to an area in which the execution screen of the application is displayed in the entire area of the touchscreen 360. For example, the display area of the touchscreen 360 may be set to be the same as or partially different from the entire area of the touchscreen 360. For example, the display area of the touchscreen 360 in which the execution screen of the application is displayed may be set to be the same or partially different for each application.

According to an embodiment, in operation 413, the electronic device 301 may identify the first input on the first object representing the second application included in the first execution screen. For example, the first object may include an icon for executing the second application or an object (e.g., text or icon) linked to the second application. According to an embodiment, the first input may include, for example, and without limitation, a touch input or a tap input. However, this is an example, and the first input may include various types of inputs. According to an embodiment, if the first input on the first object is identified, the electronic device 301 may execute the second application.

According to an embodiment, in operation 415, the electronic device 301 may display the second execution screen and a portion of the first execution screen of the second application. For example, the electronic device 301 may display the entire portion of the second execution screen in the display area of the touchscreen 360. According to an embodiment, the electronic device 301 may display the second execution screen on the first execution screen. According to an embodiment, the electronic device 301 may display a portion of the first execution screen in the display area of the touchscreen 360 so as not to overlap the second execution screen. For example, a portion of the first execution screen may include the lower area of the first execution screen. For example, a portion of the first execution screen may include the upper area of the first execution screen. For example, a portion of the first execution screen may include the type of the first application (e.g., an application related to the Internet) or the name set in the first application. According to an embodiment, a portion of the first execution screen may be displayed in the lower area or the upper area of the touchscreen 360. According to an embodiment, when displaying the second execution screen and a portion of the first execution screen, the electronic device 301 may apply a visual effect to the second execution screen and/or a portion of the first execution screen. For example, the electronic device 301 may reduce the size of the second execution screen by a predetermined ratio while maintaining the aspect ratio of the second execution screen. The electronic device 301 may reduce the size of the first execution screen by a predetermined ratio while maintaining the aspect ratio of a portion of the first execution screen. For example, the processor 320 may apply a specific color to a portion of the outline of the display area of the touchscreen 360. Accordingly, the electronic device 301 may apply a visual effect (e.g., applying white or black to the outline portion) as if there is a margin in the outline portion of the display area of the touchscreen 360.

According to an embodiment, in operation 417, the electronic device 301 may identify the second input on the second object. According to an embodiment, the second object may refer, for example, to an object for controlling the display of the first execution screen and the second execution screen. For example, the second input may include, for example, and without limitation, a swipe or drag input on the second object. According to an embodiment, the second object may be displayed in the lower area or the upper area of the touchscreen 360. According to an embodiment, the electronic device 301 may display the second object on a portion of the first execution screen. According to an embodiment, the electronic device 301 may display the second object on the second execution screen. According to an embodiment, the electronic device 301 may display the second object on a boundary surface between a portion of the first execution screen and the second execution screen. According to an embodiment, the electronic device 301 may apply a visual effect to the second object based on the second input. For example, the visual effect on the second object may include an effect indicating that the second object moves to the user. For example, if the second input on the second object is identified, the electronic device 301 may adjust the transparency of the second object.

According to an embodiment, in operation 419, the electronic device 301 may identify the movement distance and the movement direction of the second object according to the second input on the second object. According to an embodiment, the movement direction may include a vertical direction. According to an embodiment, the electronic device 301 may differently set a visual effect (or the degree to which the visual effect is applied) applied to the second object according to the movement distance of the second object. For example, as the movement distance of the second object increases, the electronic device 301 may set the transparency of the second object to be higher or lower. For example, as the movement distance of the second object increases, the electronic device 301 may set the color of the second object to be displayed dark or light. According to an embodiment, the electronic device 301 may not display the second object before a designated time from the time when the second execution screen is displayed and, after the designated time, display the second object.

According to an embodiment, in operation 421, the electronic device 301 may display the first execution screen, the second execution screen, or a portion of the first execution screen and a portion of the second execution screen based on the movement distance and the movement direction of the second object. In this case, the electronic device 301 may not display the second object. According to an embodiment, the electronic device 301 may display the entire portion of the first execution screen or the entire portion of the second execution screen in the display area of the touchscreen 360. According to an embodiment, the electronic device 301 may display a portion of the first execution screen and a portion of the second execution screen as split screens in the display area of the touchscreen 360.

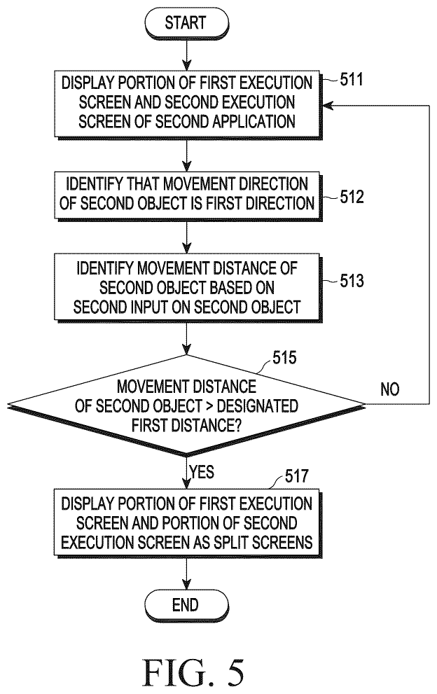

FIG. 5 is a flowchart illustrating an example operation in which an electronic

device adjusts a display area of a screen displayed on a touchscreen based on a movement distance and a movement direction of a second object according to various embodiments.

Referring to FIG. 5, according to an embodiment, in operation 511, the electronic device 301 (e.g., the electronic device 301 of FIG. 3) may display the second execution screen and a portion of the first execution screen of the second application on the touchscreen 360 (e.g., the touchscreen 360 of FIG. 3). According to an embodiment, the area in which a portion of the first execution screen is displayed may include the lower area or the upper area of the touchscreen 360. According to an embodiment, a portion of the first execution screen may include the upper area or the lower area of the first execution screen.

According to an embodiment, in operation 512, if the second input on the second object is identified, the electronic device 301 may identify that the movement direction of the second object is the first direction. According to an embodiment, the second object may be displayed in the lower area or the upper area of the touchscreen 360. According to an embodiment, the second object may be displayed on the second execution screen or on a portion of the first execution screen. According to an embodiment, when the second object and a portion of the first execution screen are displayed in the lower area of the touchscreen 360, the first direction may refer, for example, to a direction from bottom to top. According to an embodiment, when the second object and a portion of the first execution screen are displayed in the upper area of the touchscreen 360, the first direction may refer, for example, to a direction from top to bottom. According to an embodiment, the second input may include, for example, and without limitation, a touch input or a tap input.

According to an embodiment, in operation 513, the electronic device 301 may identify the movement distance of the second object based on the second input on the second object.

According to an embodiment, in operation 515, the electronic device 301 may compare the movement distance of the second object with the designated first distance. According to an embodiment, the electronic device 301 may identify whether the movement distance of the second object is larger than the first designated distance. For example, the designated first distance may be automatically set by the processor 320 or set by the user. For example, the designated first distance may be a reference distance predesignated for displaying the first execution screen and the second execution screen in the multi-window mode.

According to an embodiment, if it is identified that the movement distance of the second object is larger than the designated first distance (operation 515—Yes), in operation 517, the electronic device 301 may display a portion of the first execution screen and a portion of the second execution screen as split screens. In this case, the electronic device 301 may not display the second object. According to an embodiment, the electronic device 301 may display a portion of the first execution screen and a portion of the second execution screen, as split screens, in the display area of the touchscreen 360. According to an embodiment, the electronic device 301 may display a portion of the second execution screen in the upper area of the touchscreen 360 and a portion of the first execution screen in the lower area of the touchscreen 360. According to an embodiment, the electronic device 301 may display a portion of the first execution screen in the upper area of the touchscreen 360 and a portion of the second execution screen in the lower area of the touchscreen 360.

According to an embodiment, the electronic device 301 may determine the first area in which a portion of the first execution screen is displayed and the second area in which a portion of the second execution screen is displayed. The first area and the second area may refer, for example, to portions of the display area of the touchscreen 360. According to an embodiment, the size of the first area and the size of the second area may be set to be the same. According to an embodiment, the size of the first area and the size of the second area may be set to be different from each other.

According to an embodiment, the electronic device 301 may display the upper area of the first execution screen in the upper area of the first area. The electronic device 301 may display a portion of the first execution screen corresponding to the size of the first area with respect to the upper area of the first execution screen. According to an embodiment, the electronic device 301 may display the lower area of the first execution screen in the lower area of the first area. The electronic device 301 may display a portion of the first execution screen corresponding to the size of the first area with respect to the lower area of the first execution screen. According to an embodiment, the electronic device 301 may display the upper area of the second execution screen in the upper area of the second area. The electronic device 301 may display a portion of the second execution screen corresponding to the size of the second area with respect to the upper area of the second execution screen. According to an embodiment, the electronic device 301 may display the lower area of the second execution screen in the lower area of the second area. The electronic device 301 may display a portion of the second execution screen corresponding to the size of the second area with respect to the lower area of the second execution screen. According to an embodiment, the electronic device 301 may determine the central area of the first execution screen as the upper or lower area of the first area. The electronic device 301 may display a portion of the first execution screen to correspond to the size of the first area with respect to a specific area of the first execution screen (e.g., a central area of the entire first execution screen). According to an embodiment, the electronic device 301 may determine the central area of the second execution screen as the upper or lower area of the second area. The electronic device 301 may display a portion of the second execution screen to correspond to the size of the second area with respect to a specific area of the second execution screen (e.g., a central area of the entire second execution screen). According to an embodiment, a portion of the first execution screen may include the first object. According to an embodiment, the electronic device 301 may display a portion of the first execution screen on which the first object is displayed as a portion of the first execution screen. In this case, the electronic device 301 may display the first object to be visually distinguished. For example, the electronic device 301 may apply a color to the first object to be visually distinguished. For example, the electronic device 301 may adjust the transparency of the first object or apply a specific color to the first object. However, this is an example, and a portion of the first execution screen corresponding to the size of the first area and a portion of the second execution screen corresponding to the size of the second area are not limited thereto.

According to an embodiment, if it is identified that the movement distance of the second object is not larger than the designated first distance (operation 515—No), in operation 511, the electronic device 301 may maintain the display of the second execution screen and a portion of the first execution screen. For example, if it is identified that the movement distance of the second object is not larger than the designated first distance, the electronic device 301 may display the second execution screen and a portion of the first execution screen of the second application as before.

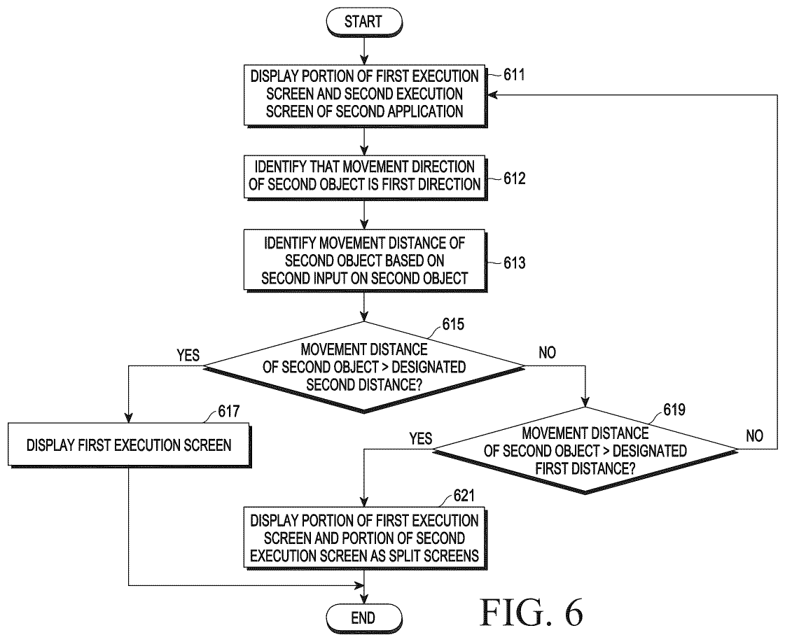

FIG. 6 is a flowchart illustrating an example operation in which an electronic device adjusts a display area of a screen displayed on a touchscreen based on a movement distance and a movement direction of a second object according to various embodiments.

Referring to FIG. 6, according to an embodiment, in operation 611, the electronic device 301 (e.g., the electronic device 301 of FIG. 3) may display the second execution screen and a portion of the first execution screen of the second application on the touchscreen 360 (e.g., the touchscreen 360 of FIG. 3).

According to an embodiment, in operation 612, if the second input on the second object is identified, the electronic device 301 may identify that the movement direction of the second object is the first direction.

According to an embodiment, in operation 613, the electronic device 301 may identify the movement distance of the second object based on the second input on the second object.

According to an embodiment, in operation 615, the electronic device 301 may compare the movement distance of the second object with the designated second distance. According to an embodiment, the electronic device 301 may identify whether the movement distance of the second object is larger than the designated second distance. For example, the designated second distance may be automatically set by the processor 320 or may be set by the user. For example, the designated second distance may be a reference distance predesignated to display only the first execution screen instead of the multi-window mode.

According to an embodiment, if it is identified that the movement distance of the second object is larger than the designated second distance (operation 615—Yes), in operation 617, the electronic device 301 may display the first execution screen on the touchscreen 360. According to an embodiment, the electronic device 301 may display the entire portion of the first execution screen in the display area of the touchscreen 360. According to an embodiment, the electronic device 301 may not display the second execution screen. According to an embodiment, the electronic device 301 may display the first object included in the first execution screen to be visually distinguished. According to an embodiment, the electronic device 301 may apply a visual effect to the first object. For example, the electronic device 301 may adjust the transparency of the first object or apply a color to the first object. Accordingly, the electronic device 301 may visually display that the display of the execution screen of the second application executed based on the first object has been terminated. According to an embodiment, if a tap input or a touch input is identified by the touchscreen 360, the electronic device 301 may release the visual effect applied to the first object.

According to an embodiment, if it is identified that the movement distance of the second object is not larger than the designated second distance (operation 615—No), in operation 619, the electronic device 301 may compare the movement distance of the second object with the designated first distance. According to an embodiment, the electronic device 301 may identify whether the movement distance of the second object is larger than the first designated distance. According to an embodiment, the first distance may refer, for example, to a distance smaller than the second distance. For example, the designated first distance may be a reference distance predesignated for displaying the first execution screen and the second execution screen in the multi-window mode.

According to an embodiment, if it is identified that the movement distance of the second object is larger than the designated first distance (operation 619—Yes), in operation 621, a portion of the first execution screen and a portion of the second execution screen may be displayed as split screens in the display area of the touchscreen.

According to an embodiment, if it is identified that the movement distance of the second object is not larger than the designated first distance (operation 619—No), in operation 611, the electronic device 301 may display the second execution screen and a portion of the first execution screen.

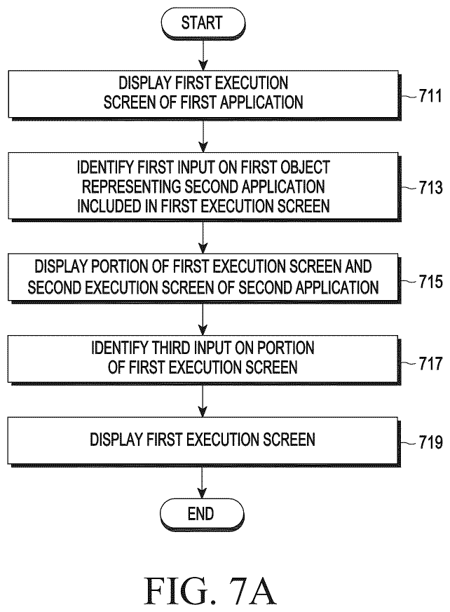

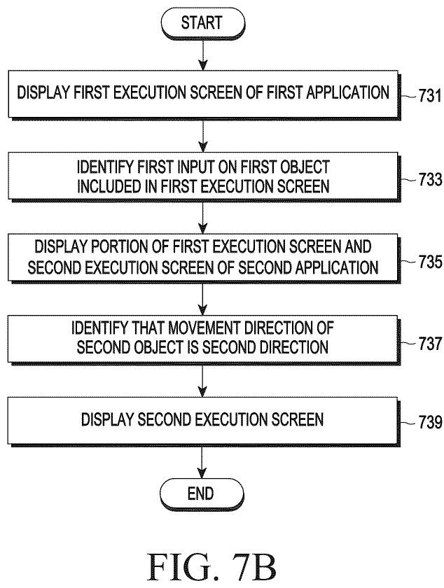

FIG. 7A is a flowchart illustrating an example operation in which an electronic device displays a first execution screen based on a third input, according to various embodiments.

Referring to FIG. 7A, according to an embodiment, in operation 711, the electronic device 301 (e.g., the electronic device 301 of FIG. 3) may display the first execution screen of the first application on the touchscreen 360 (e.g., the touchscreen 360 of FIG. 3). According to an embodiment, the area in which a portion of the first execution screen is displayed may include the lower area of the touchscreen 360.

According to an embodiment, in operation 713, the electronic device 301 may identify the first input on the first object representing the second application included in the first execution screen.

According to an embodiment, in operation 715, the electronic device 301 may display the second execution screen and a portion of the first execution screen of the second application.

According to an embodiment, in operation 717, the electronic device 301 may identify the third input on a portion of the first execution screen. According to an embodiment, the third input may include, for example, and without limitation, a tap input or a touch input.

According to an embodiment, in operation 719, the electronic device 301 may display the first execution screen. According to an embodiment, the electronic device 301 may display the entire portion of the first execution screen in the display area of the touchscreen 360. In this case, the electronic device 301 may not display the second object. According to an embodiment, the electronic device 301 may terminate the execution of the second application and may not display the second execution screen.

According to an embodiment, the electronic device 301 may distinctly display the first object included in the first execution screen. According to an embodiment, the electronic device 301 may apply a visual effect to the first object. For example, the electronic device 301 may adjust the transparency of the first object or apply a color to the first object. According to an embodiment, if a tap input or a touch input is identified by the touchscreen 360, the electronic device 301 may release the visual effect applied to the first object. Accordingly, the electronic device 301 may visually display that the display of the second execution screen of the second application executed based on the first object has been terminated.

FIG. 7B is a flowchart illustrating an example operation in which an electronic device displays a second execution screen based on a movement direction of a second object, according to various embodiments.

Referring to FIG. 7B, according to an embodiment, in operation 731, the electronic device 301 (e.g., the electronic device 301 of FIG. 3) may display the first execution screen of the first application on the touchscreen 360 (e.g., the touchscreen 360 of FIG. 3).

According to an embodiment, in operation 733, the electronic device 301 may identify the first input on the first object representing the second application included in the first execution screen.

According to an embodiment, in operation 735, the electronic device 301 may display the second execution screen and a portion of the first execution screen of the second application. According to an embodiment, a portion of the first execution screen may be displayed in the upper or lower area of the touchscreen 360.

According to an embodiment, in operation 737, the electronic device 301 may identify that the movement direction of the second input on the second object is the second direction. According to an embodiment, the second object may be displayed in the lower area or the upper area of the touchscreen 360. According to an embodiment, the second object may be displayed on the second execution screen or on a portion of the first execution screen. According to an embodiment, the second object may be displayed on a boundary surface of the second execution screen and a portion of the first execution screen. According to an embodiment, when the second object is displayed in the lower area of the touchscreen 360 and a portion of the first execution screen is displayed in the lower area of the touchscreen 360, the second direction may refer, for example, to a direction from top to bottom. According to an embodiment, when the second object is displayed in the upper area of the touchscreen 360 and a portion of the first execution screen is displayed in the upper area of the touchscreen 360, the second direction may refer, for example, to a direction from bottom to top. According to an embodiment, the second input may include, for example, and without limitation, a touch input or a tap input.

According to an embodiment, in operation 739, the electronic device 301 may display the second execution screen based on the second input in which the movement direction is the second direction. According to an embodiment, the electronic device 301 may display the entire portion of the second execution screen in the display area of the touchscreen 360. In this case, the electronic device 301 may not display a portion of the first execution screen.

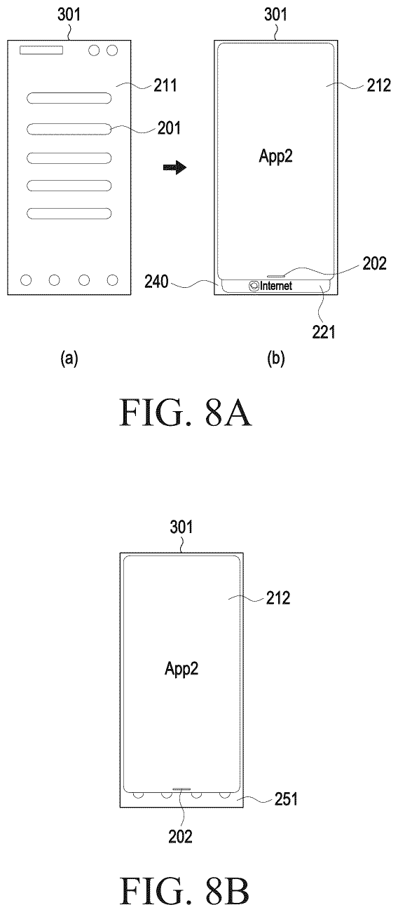

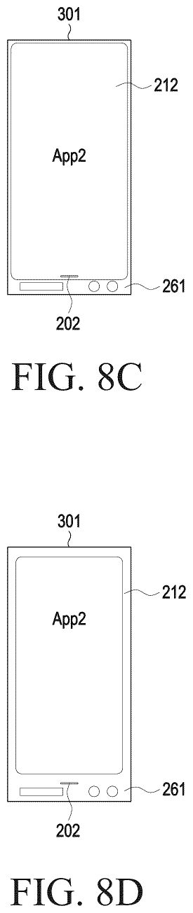

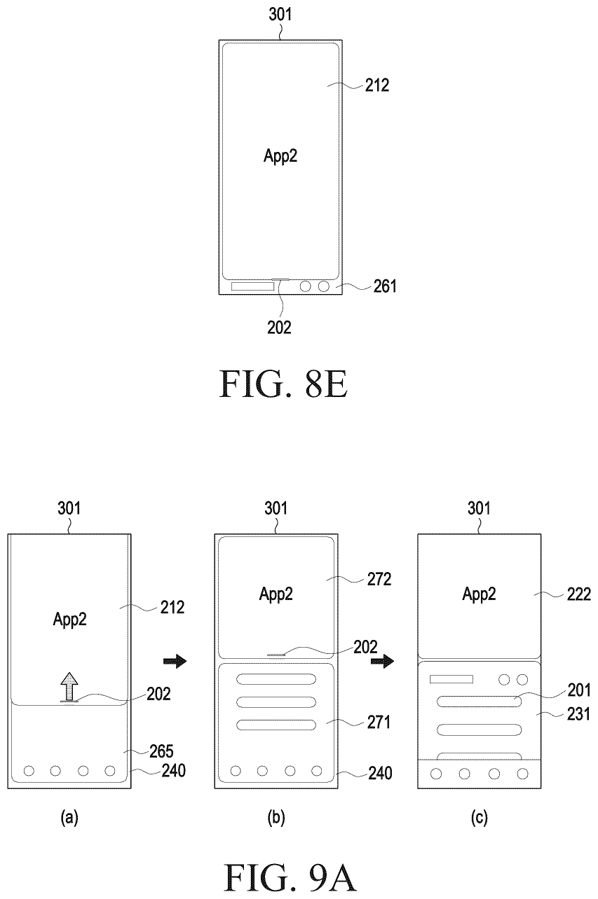

FIG. 8A is a diagram illustrating an example operation in which an electronic device displays a second execution screen based on an input on a first object included in a first execution screen according to various embodiments.

Referring to FIG. 8A(a), according to an embodiment, if an input for executing the first application is identified, the electronic device 301 (e.g., the electronic device 301 of FIG. 3) may execute the first application among the plurality of applications stored in the memory 350 (e.g., the memory 350 of FIG. 3). According to an embodiment, the electronic device 301 may display the first execution screen 211 of the first application on the touchscreen 360 (e.g., the touchscreen 360 of FIG. 3). For example, the electronic device 301 may display the first execution screen 211 in the display area of the touchscreen 360.

According to an embodiment, the first execution screen 211 may include the first object 201 representing the second application. For example, the first object may include an icon of the second application or information linked to the second application (e.g., a uniform resource locator (URL) address).

According to an embodiment, the electronic device 301 may identify the first input on the first object 201. According to an embodiment, the first input may include a touch input or a tap input. However, this is an example, and the first input may include various types of inputs. According to an embodiment, if the first input on the first object is identified, the electronic device 301 may execute the second application stored in the memory 350.

Referring to FIG. 8A(b), according to an embodiment, the electronic device 301 may display the second execution screen 212 and a portion 221 of the first execution screen of the second application based on the first input on the first object 201. For example, the electronic device 301 may display the second execution screen 212 in the display area of the touchscreen 360. According to an embodiment, the electronic device 301 may display the second execution screen 212 on the first execution screen 211. According to an embodiment, the electronic device 301 may display the portion 221 of the first execution screen so as not to overlap the second execution screen 212. According to an embodiment, the portion 221 of the first execution screen may be displayed in the lower area of the touchscreen 360. The portion 221 of the first execution screen may include the type of the first application (e.g., an application related to the Internet).

According to an embodiment, the second execution screen 212 may include a second object 202. According to an embodiment, the second object 202 may refer, for example, to an object for adjusting the display area of the first execution screen 211 and the second execution screen 212. According to an embodiment, the second object 202 may be displayed on the second execution screen 212.

According to an embodiment, when displaying the second execution screen 212 and the portion 221 of the first execution screen, the electronic device 301 may apply a visual effect to the second execution screen 212 and the portion 221 of the first execution screen. For example, the visual effect may include an effect indicating entry into a mode for controlling the display of two screens to the user. For example, the electronic device 301 may reduce the size of the second execution screen 212 by a predetermined ratio while maintaining the aspect ratio of the second execution screen 212. The electronic device 301 may reduce the size of the portion 221 of the first execution screen by a predetermined ratio while maintaining the aspect ratio of the portion 221 of the first execution screen. For example, the electronic device 301 may apply a specific color to a portion of the outline of the display area of the touchscreen 360. Accordingly, the electronic device 301 may apply a visual effect (e.g., applying white or black to the outline portion) as if there is a margin in the outline portion of the display area of the touchscreen 360.

According to an embodiment, the electronic device 301 may identify the second input on the second object 202. The second input may include a touch input or a tap input. According to an embodiment, the electronic device 301 may identify the movement distance and movement direction of the second object 202 according to the second input. According to an embodiment, the electronic device 301 may control the display of the first execution screen 211 and the second execution screen 212 based on the movement distance and movement direction of the second object 212.

FIGS. 8B, 8C, 8D, and 8E are diagrams illustrating an example operation in which an electronic device displays a second object on a first execution screen and/or a second execution screen according to various embodiments.

Referring to FIG. 8B, according to an embodiment, the electronic device 301 (e.g., the electronic device 301 of FIG. 3) may display the second execution screen 212 and the portion 251 of the first execution screen of the second application on the touchscreen 360 (e.g., the touchscreen 360 of FIG. 3).

According to an embodiment, the second object 202 may be displayed on the second execution screen 212.

According to an embodiment, the portion 251 of the first execution screen may include the lower area of the first execution screen 211.

According to an embodiment, when displaying the second execution screen 212 and the portion 251 of the first execution screen, the electronic device 301 may apply a visual effect to the second execution screen 212. For example, the electronic device 301 may reduce the size of the second execution screen 212 by a predetermined ratio while maintaining the aspect ratio of the second execution screen 212.

Referring to FIG. 8C, according to an embodiment, the portion 261 of the first execution screen may include the upper area of the first execution screen 211. According to an embodiment, the second object 202 may be displayed on the second execution screen 212.

Referring to FIG. 8D, according to an embodiment, the portion 261 of the first execution screen may include the upper area of the first execution screen 211. According to an embodiment, the second object 202 may be displayed on the second execution screen 212. Referring to FIG. 8E, according to an embodiment, the portion 261 of the first

execution screen may include the upper area of the first execution screen 211. According to an embodiment, the second object 202 may be displayed on a boundary surface between the portion 261 of the first execution screen and the second execution screen 212.

FIG. 9A is a diagram illustrating an example operation in which an electronic device adjusts a display area of a screen displayed on a touchscreen based on a movement distance and a movement direction of a second object, according to various embodiments.

Referring to FIG. 9A(a), according to an embodiment, the electronic device 301 (e.g., the electronic device 301 of FIG. 3) may identify an input on the second object 202 included in the second execution screen 212 displayed on the touchscreen 360 (e.g., the touchscreen 360 of FIG. 3). According to an embodiment, the electronic device 301 may identify the movement direction and the movement distance of the second object 202. According to an embodiment, the input may include, for example, and without limitation a swipe input or a drag input.

According to an embodiment, the electronic device 301 may identify that the movement direction of the second object 202 is the first direction from bottom to top. According to an embodiment, if the second object 202 is moved in the first direction, the electronic device 301 may display the portion 265 of the first execution screen overlapping the second execution screen 212. According to an embodiment, the electronic device 301 may apply a visual effect to the second execution screen 212 and the portion 265 of the first execution screen. For example, the electronic device 301 may reduce the size of the second execution screen 212 by a predetermined ratio while maintaining the aspect ratio of the second execution screen 212. The electronic device 301 may reduce the size of the portion 265 of the first execution screen by a predetermined ratio while maintaining the aspect ratio of the portion 265 of the first execution screen. Through this, the electronic device 301 may apply a visual effect as if there is a margin 240 in an outline portion of the display area of the touchscreen 360.

Referring to FIG. 9A(b), the electronic device 301 may identify that the movement distance of the second object 202 is larger than the first designated distance and smaller than the second designated distance. The designated second distance may have a value larger than the designated first distance. According to an embodiment, the electronic device 301 may display a portion 271 of the first execution screen and a portion 272 of the second execution screen as split screens.

Referring to FIG. 9A(c), if the input on the second object 202 is released, the electronic device 301 may display the portion 231 of the first execution screen and the portion 222 of the second execution screen, as split screens, in the display area of the touchscreen 360. According to an embodiment, the electronic device 301 may not display the second object 202. According to an embodiment, the electronic device 301 may release a visual effect having a blank 240 in an outline portion of the display area of the touchscreen 360. According to an embodiment, the electronic device 301 may display the portion 231 of the first execution screen in the lower area of the touchscreen 360 and a portion of the second execution screen 222 in the upper area of the touchscreen 360.

According to an embodiment, the size of the first area in which the portion 231 of the first execution screen is displayed may be the same as the size of the second area in which the portion of the second execution screen 222 is displayed. According to an embodiment, the portion 231 of the first execution screen may include the first object 231.

FIG. 9B is a diagram illustrating an example operation in which an electronic device adjusts a display area of a screen displayed on a touchscreen based on a movement distance and a movement direction of a second object, according to various embodiments.

Referring to FIG. 9B(a), according to an embodiment, the electronic device 301 (e.g., the electronic device 301 of FIG. 3) may identify an input on the second object 202 included in the second execution screen 212 displayed on the touchscreen 360 (e.g., the touchscreen 360 of FIG. 3). According to an embodiment, the electronic device 301 may identify the movement direction and the movement distance of the second object 202.

According to an embodiment, the electronic device 301 may identify that the movement direction of the second object 202 is the first direction from bottom to top. According to an embodiment, if the second object 202 is moved in the first direction, the electronic device 301 may display the portion 265 of the first execution screen overlapping the second execution screen 212. According to an embodiment, the electronic device 301 may apply a visual effect to the second execution screen 212 and the portion 265 of the first execution screen.

According to an embodiment, the electronic device 301 may identify that the movement distance of the second object 202 is not larger than the designated first distance.

Referring to FIG. 9B(b), according to an embodiment, the electronic device 301 may display the second execution screen 212 and the portion 221 of the first execution screen based on identifying that the movement distance of the second object 202 is not larger than the designated first distance.

According to an embodiment, the portion 221 of the first execution screen may include the type of the first application (e.g., an application related to the Internet). For example, the portion 221 of the first execution screen may include the upper area or the lower area of the first execution screen 211.

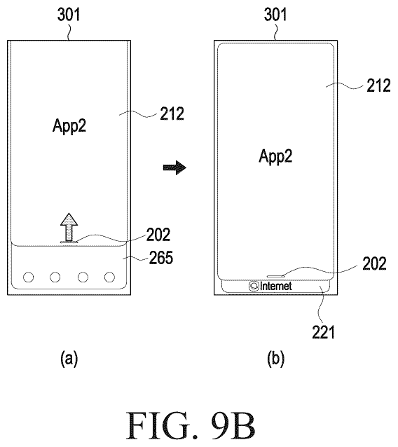

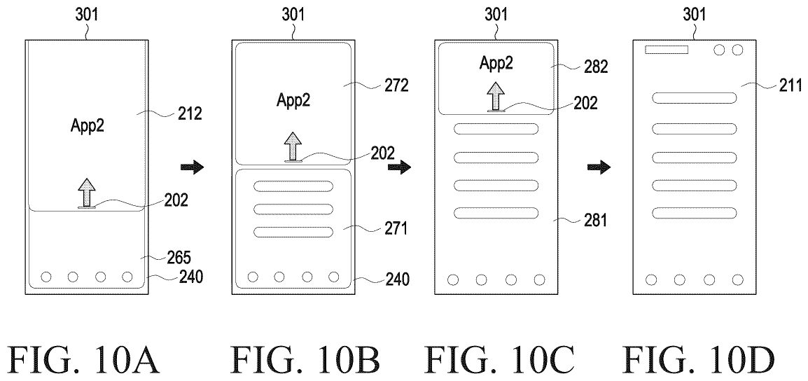

FIGS. 10A, 10B, 10C and 10D are diagrams illustrating an example operation in which an electronic device displays a first execution screen based on a movement distance and a movement direction of a second object, according to various embodiments.

Referring to FIG. 10A, according to an embodiment, the electronic device 301 (e.g., the electronic device 301 of FIG. 3) may identify the second input on the second object 202 included in the second execution screen 212. According to an embodiment, the second input may include a swipe or drag input. According to an embodiment, the electronic device 301 may identify that the movement direction of the second object 202 is the first direction in which the second object 202 moves from bottom to top.

According to an embodiment, if the second object 202 is moved in the first direction, the electronic device 301 may display the portion 265 of the first execution screen overlapping the second execution screen 212. According to an embodiment, the electronic device 301 may apply a visual effect to the second execution screen 212 and the portion 265 of the first execution screen. For example, the electronic device 301 may reduce the size of the second execution screen 212 by a predetermined ratio while maintaining the aspect ratio of the second execution screen 212. The electronic device 301 may reduce the size of the portion 265 of the first execution screen by a predetermined ratio while maintaining the aspect ratio of the portion 265 of the first execution screen. Through this, the electronic device 301 may apply a visual effect as if there is a margin 240 in an outline portion of the display area of the touchscreen 360.

Referring to FIG. 10B, the electronic device 301 may identify that the movement distance of the second object 202 is larger than the first designated distance and smaller than the second designated distance. According to an embodiment, the electronic device 301 may display a portion 271 of the first execution screen and a portion 272 of the second execution screen as split screens. According to an embodiment, the designated second distance may refer, for example, to a distance having a value larger than the designated first distance.

Referring to FIG. 10C, the electronic device 301 may identify that the movement distance of the second object 202 is larger than designated second distance. According to an embodiment, the electronic device 301 may not apply a visual effect to the portion 265 of the first execution screen. According to an embodiment, the electronic device 301 may release a visual effect having a blank 240 in an outline portion of the display area of the touchscreen 360. According to an embodiment, the electronic device 301 may not display the portion 281 of the first execution screen and the portion 282 of the second execution screen as split screens.

Referring to FIG. 10D, if the input on the second object 202 is released, the electronic device 301 may display the first execution screen 211 in the display area of the touchscreen 360. According to an embodiment, the electronic device 301 may not display the second object 202. According to an embodiment, the electronic device 301 may terminate the execution of the second application and may not display the second execution screen 212.

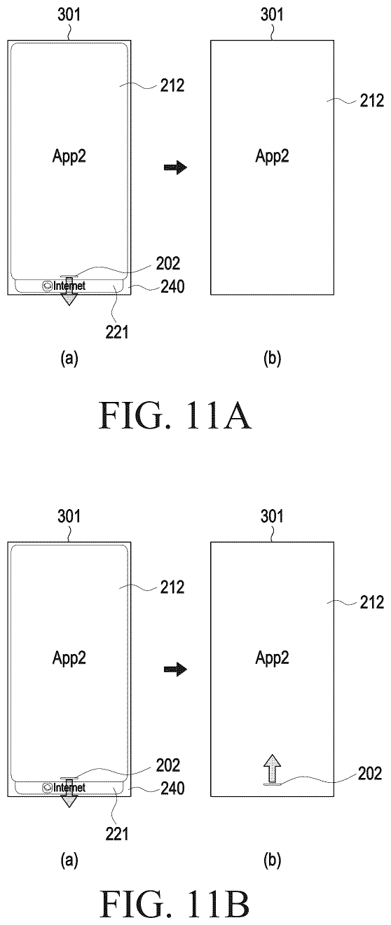

FIG. 11A is a diagram illustrating an example operation in which an electronic device displays a second execution screen based on a movement direction of a second object, according to various embodiments.

Referring to FIG. 11A(a), according to an embodiment, the electronic device 301 (e.g., the electronic device 301 of FIG. 3) may display the second execution screen 212 and the portion 221 of the first execution screen on the touchscreen 360 (e.g., the touchscreen 360 of FIG. 3). According to an embodiment, the electronic device 301 may apply a visual effect as if there is a margin 240 in an outline portion of the display area of the touchscreen 360.

According to an embodiment, the electronic device 301 may identify the second input on the second object 202. The second input may include a drag or swipe input. According to an embodiment, the electronic device 301 may identify that the movement direction of the second object 202 is the second direction from top to bottom.

Referring to FIG. 11A(b), according to an embodiment, if the second input is released, the electronic device 301 may display the second execution screen 212 without displaying the portion 221 of the first execution screen. According to an embodiment, the electronic device 301 may not display the second object 202. According to an embodiment, the electronic device 301 may not apply a visual effect as if there is a margin 240 in an outline portion of the display area of the touchscreen 360.

According to an embodiment, if the third input on the portion 221 of the first execution screen illustrated in FIG. 11A is identified, the electronic device 301 may display the second execution screen 212 without displaying the portion 221 of the first execution screen.

FIG. 11B is a diagram illustrating an example operation in which an electronic device displays a second execution screen based on a movement direction of a second object, according to various embodiments.

Referring to FIG. 11B(a), according to an embodiment, the electronic device 301 (e.g., the electronic device 301 of FIG. 3) may display the second execution screen 212 and the portion 221 of the first execution screen on the touchscreen 360 (e.g., the touchscreen 360 of FIG. 3).

According to an embodiment, the electronic device 301 may identify a drag or swipe input on the second object 202. According to an embodiment, the electronic device 301 may identify that the movement direction of the second object 202 is the second direction from top to bottom.

Referring to FIG. 11B(b), according to an embodiment, if the drag or swipe input is released, the electronic device 301 may display the second execution screen 212 without displaying the portion 221 of the first execution screen. According to an embodiment, the electronic device 301 may display the second object 202.

According to an embodiment, the electronic device 301 may identify a drag or swipe input on the second object 202. According to an embodiment, the electronic device 301 may identify that the movement direction of the second object 202 is the first direction from bottom to top. According to an embodiment, based on identifying that the drag or swipe input is in the first direction, the electronic device 301 may display the second execution screen 212 and the portion 221 of the first execution screen again as illustrated in FIG. 11B(a). According to an embodiment, the electronic device 301 may again apply a visual effect as if there is a margin 240 in an outline portion of the display area of the touchscreen 360.

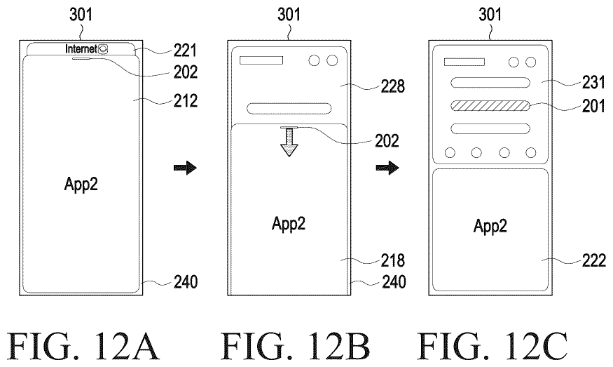

FIGS. 12A, 12B and 12C are diagrams illustrating an example operation in which an electronic device adjusts a display area of a screen displayed on a touchscreen based on a movement distance and a movement direction of a second object, according to various embodiments.

Referring to FIG. 12A, according to an embodiment, the electronic device 301 (e.g., the electronic device 301 of FIG. 3) may display the second execution screen 212 and the portion 221 of the first execution screen of the second application. For example, the electronic device 301 may display the second execution screen 212 in the display area of the touchscreen 360. According to an embodiment, the portion 221 of the first execution screen may be displayed in the upper area of the touchscreen 360. The portion 221 of the first execution screen may include the type of the first application (e.g., an application related to the Internet).

According to an embodiment, the electronic device 301 may apply a visual effect as if there is a margin 240 in an outline portion of the display area of the touchscreen 360.

According to an embodiment, the second object 202 may be displayed on the second execution screen 212. According to an embodiment, the second object 202 may be displayed in the upper area of the touchscreen 360.

Referring to FIG. 12B, according to an embodiment, the electronic device 301 may identify the second input on the second object 202. According to an embodiment, the electronic device 301 may identify the movement distance and movement direction of the second object 202 according to the second input. According to an embodiment, the electronic device 301 may identify that the movement direction of the second object 202 is the direction from top to bottom. The second input may include, for example, and without limitation, a swipe or drag input on the second object 202.

According to an embodiment, if the second input on the second object 202 is identified, the electronic device 301 may display the portion 228 of the first execution screen indicating the upper area of the first execution screen. According to an embodiment, as the electronic device 301 displays the portion 228 of the first execution screen, the electronic device 301 may not display the portion of the second execution screen 212. According to an embodiment, as the electronic device 301 does not display a portion of the second execution screen 212, the electronic device 301 may display the portion 218 of the second execution screen.

Referring to FIG. 12C, according to an embodiment, the electronic device 301 may identify that the second input on the second object 202 has been released. According to an embodiment, the electronic device 301 may identify that the movement distance of the second object 202 is larger than the first designated distance and not larger than the second designated distance. The designated second distance may be a distance having a larger value than the designated first.

According to an embodiment, the electronic device 301 may display the portion 231 of the first execution screen and the portion 222 of the second execution screen, as split screens, in the display area of the touchscreen 360. According to an embodiment, the electronic device 301 may not display the second object 202. According to an embodiment, the electronic device 301 may not apply a visual effect such as having a margin 240 on the touchscreen 360. According to an embodiment, the electronic device 301 may display the portion 231 of the first execution screen in the upper area of the touchscreen 360 and the portion of the second execution screen 222 in the lower area of the touchscreen 360. According to an embodiment, the electronic device 301 may not display the second object 202.

According to an embodiment, the size of the first area in which the portion 231 of the first execution screen is displayed may be the same as the size of the second area in which the portion of the second execution screen 222 is displayed.

According to an embodiment, the portion 231 of the first execution screen may include the first object 201. According to an embodiment, the electronic device 301 may apply a visual effect to the first object 201 to be displayed to be distinguished.

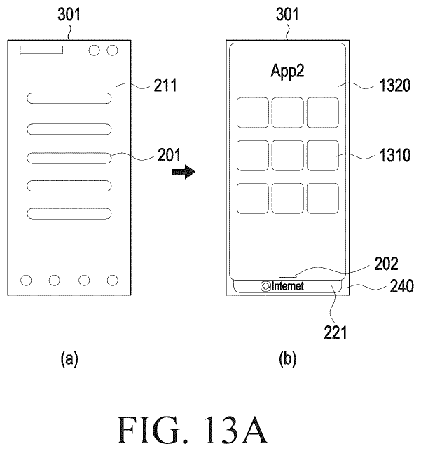

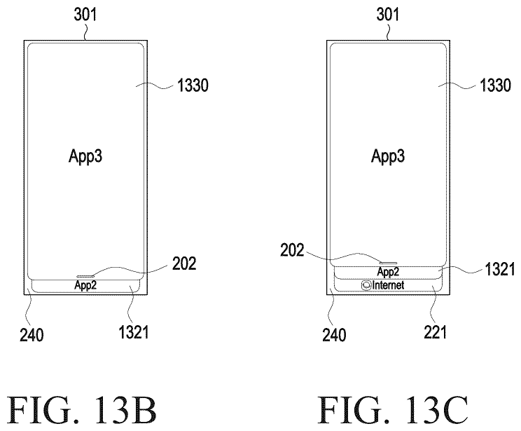

FIG. 13A is a diagram illustrating a second execution screen of a second application according to various embodiments.

Referring to FIG. 13A(a), according to an embodiment, the electronic device 301 (e.g., the electronic device 301 of FIG. 3) may display the first execution screen 211 of the first application. According to an embodiment, the first execution screen 211 may include the first object 201 representing the second application. For example, the first object 201 may include an icon of the second application or information linked to the second application (e.g., a uniform resource locator (URL) address). For example, the first object 201 may include at least one icon capable of executing at least one function included in the execution screen of the first application. The at least one icon may refer, for example, to an icon capable of displaying a screen different from that of the first execution screen 211. However, this is an example, and the first object 201 is not limited thereto.

According to an embodiment, the electronic device 301 may identify an input on the first object 201. According to an embodiment, the input may include, for example, and without limitation, a touch input or a tap input.

Referring to FIG. 13A(b), according to an embodiment, the electronic device 301 may display the second execution screen 1320 and a portion 221 of the first execution screen of the second application upon identifying the input on the first object 201. According to an embodiment, the portion 221 of the first execution screen may include the type of the first application (e.g., an application related to the Internet). According to an embodiment, the portion 221 of the first execution screen may include at least a portion of the first execution screen 211. According to an embodiment, the portion 221 of the first execution screen may include a keyword included in the first execution screen 211. For example, the keyword may refer, for example, to information included in the first execution screen 211. For example, the keyword may be input by the user or may be input by the processor 32. According to an embodiment, the portion 221 of the first execution screen may include information related to the task being executed in the first application.

According to an embodiment, the second execution screen 1320 may include the third object 1310 representing the third application. According to an embodiment, the second execution screen 1320 may include the second object 202 for adjusting the display area of the first execution screen 211 and the second execution screen 1320. The second object 202 may be displayed in the lower area of the touchscreen 360.

FIG. 13B is a diagram illustrating a third execution screen of a third application according to various embodiments.

Referring to FIG. 13B, according to an embodiment, the electronic device 301 (e.g., the electronic device 301 of FIG. 3) may display a portion 1321 of the second execution screen and the third execution screen 1330 based on an input on the third object (1310 of FIG. 13A). According to an embodiment, the third execution screen 1330 may include a second object 202. According to an embodiment, the portion 1321 of the second execution screen may include the name (e.g., App2) of the second application. According to an embodiment, the portion 1321 of the second execution screen may include the upper area or the lower area of the second execution screen 1330.

According to an embodiment, the electronic device 301 may identify an input on the second object 202. According to an embodiment, the electronic device 301 may display a portion of the second execution screen 1320 and a portion of the third execution screen 1330 based on the movement direction and the movement distance for the second object 202.

FIG. 13C is a diagram illustrating a third execution screen of a third application according to various embodiments.

Referring to FIG. 13C, according to an embodiment, the electronic device 301 (e.g., the electronic device 301 of FIG. 3) may display a portion 221 of the first execution screen, a portion 1321 of the second execution screen, and the third execution screen 1330 based on an input on the third object (1310 of FIG. 13A).

According to an embodiment, the second object 202 may be displayed on the third execution screen 1330. According to an embodiment, the second object 202 may be displayed on the portion 221 of the first execution screen or the portion 1321 of the second execution screen. According to an embodiment, the second object 202 may be displayed on a boundary surface between the portion 221 of the first execution screen and the portion 1321 of the second execution screen or a boundary surface between the portion 1321 of the second execution screen and the third execution screen 1330.

According to an embodiment, the electronic device 301 may display a portion of the first execution screen 211, a portion of the second execution screen 1320, and a portion of the third execution screen 1330 in a multi-window based on the movement direction and the movement distance for the second object 202. For example, if it is identified that the movement direction of the second object 202 is a direction from bottom to top, and the movement distance of the second object 202 according to a swipe or drag input on the second object 202 is larger than the designated first distance, the electronic device 301 may display a portion of the first execution screen 211, a portion of the second execution screen 1320, and a portion of the third execution screen 1330 in a multi-window. If it is identified that the movement direction of the second object 202 is a direction from bottom to top, and the movement distance of the second object 202 according to the swipe or drag input on the second object 202 is larger than the designated first distance, the electronic device 301 may display a portion of the second execution screen 1320 and a portion of the third execution screen 1330 in a multi-window. In this case, the portion 221 of the first execution screen may not be displayed.

According to an embodiment, if it is identified that the movement direction of the second object 202 is a movement direction from top to bottom, the electronic device 301 may not display the portion 1321 of the second execution screen and the portion 221 of the first execution screen, but may display only the third execution screen 1330.

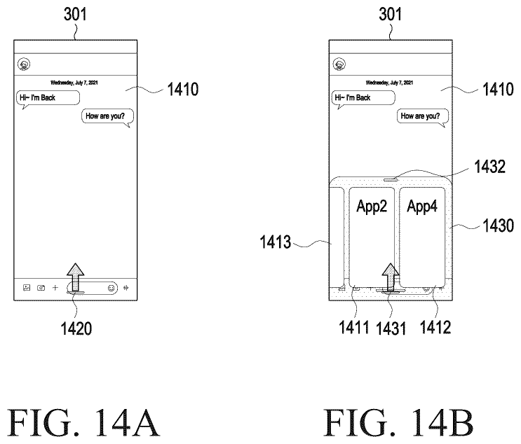

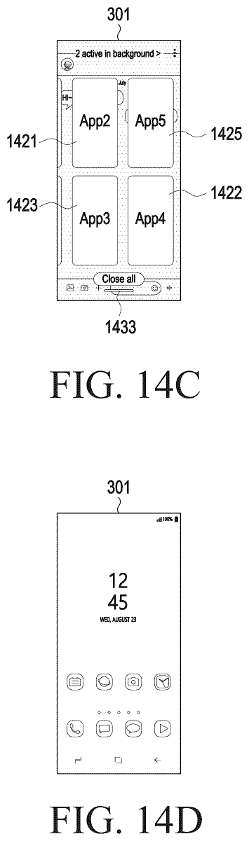

FIG. 14A is a diagram illustrating a first execution screen of a first application according to various embodiments. FIG. 14D is a diagram illustrating a home screen of an electronic device according to various embodiments.

Referring to FIG. 14A, according to an embodiment, the electronic device 301 (e.g., the electronic device 301 of FIG. 3) may execute a first application stored in the memory 350 (e.g., the memory 350 of FIG. 3). According to an embodiment, the electronic device 301 may display the first execution screen 1410 based on the execution of the first application.

According to an embodiment, the electronic device 301 may display the execution screen of at least one application stored in the memory 350 or an object 1420 for displaying the home screen of the electronic device 301. According to an embodiment, the at least one application may include at least one application whose execution has not been terminated. According to an embodiment, the at least one application may include at least one application installed in the electronic device 301. According to an embodiment, the object 1420 may be displayed in the lower area of the first execution screen 1410.

According to an embodiment, the electronic device 301 may identify an input on the object 1420. According to an embodiment, the input on the object 1420 may include a swipe or drag input. According to an embodiment, the electronic device 301 may identify an input of swiping or dragging the object 1420 from bottom to top.

According to an embodiment, when the movement distance of the object 1420 according to the input on the object 1420 is larger than a preset first value and smaller than a preset second value, the electronic device 301 may display the home screen of the electronic device 301 illustrated in FIG. 14D on the touchscreen 360. According to implementation, when the movement distance of the object 1420 according to the input on the object 1420 is larger than the preset second value, the electronic device 301 may display the home screen of the electronic device 301 illustrated in FIG. 14D on the touchscreen 360.

According to an embodiment, when the movement speed of the object 1420 according to the input on the object 1420 is larger than a preset third value and smaller than a preset fourth value, the electronic device 301 may display the home screen of the electronic device 301 illustrated in FIG. 14D on the touchscreen 360. According to an embodiment, when the movement speed of the object 1420 according to the input on the object 1420 is larger than the preset fourth value, the electronic device 301 may display the home screen of the electronic device 301 illustrated in FIG. 14D on the touchscreen 360.

FIG. 14B is a diagram illustrating an example operation in which an electronic device displays an execution screen of at least one application based on an input on a first execution screen according to various embodiments.

Referring to FIG. 14B, the electronic device 301 (e.g., the electronic device 301 of FIG. 3) may display the execution screen of at least one application in the lower area 1430 of the touchscreen 360 if an input of swiping or dragging an object (1420 of FIG. 14A) from bottom to top is identified. According to an embodiment, when the movement distance of the object 1420 according to the input on the object 1420 of FIG. 14A is larger than the preset second value, the electronic device 301 may display the execution screen of at least one application in the lower area 1430 of the touchscreen 360. According to an embodiment, when the movement speed of the object 1420 according to the input on the object 1420 is larger than the preset fourth value, the electronic device 301 may display the execution screen of at least one application in the lower area 1430 of the touchscreen 360. According to an embodiment, when the movement distance of the object 1420 according to the input on the object 1420 is larger than the preset first value and smaller than the preset second value, the electronic device 301 may display the execution screen of at least one application in the lower area 1430 of the touchscreen 360. According to an embodiment, when the movement speed of the object 1420 according to the input on the object 1420 is larger than the preset third value and smaller than the preset fourth value, the electronic device 301 may display the execution screen of at least one application in the lower area 1430 of the touchscreen 360.

According to an embodiment, the electronic device 301 may display the second execution screen 1411 of the second application, the portion 1413 of the third execution screen 1413 of the third application, and the fourth execution screen 1412 of the fourth application in the lower area 1430 of the touchscreen 360 (e.g., the touchscreen 360 of FIG. 3). However, this is an example, and the area in which the execution screen of at least one application is displayed may not be limited to the lower area 1430 of the touchscreen 360. According to an embodiment, the electronic device 301 may display the second execution screen 1411, the portion 1413 of the third execution screen, and the fourth execution screen 1412 on the first execution screen 1410. According to an embodiment, the electronic device 301 may apply a visual effect to the first execution screen 1410 displayed in the lower area 1430 of the touchscreen 360. For example, the electronic device 301 may adjust the transparency of the portion of the first execution screen 1410 overlapping the second execution screen 1411, the portion 1413 of the third execution screen 1413, and the fourth execution screen 1412. However, this is an example, and embodiments of the disclosure may apply a visual effect to the first execution screen 1410 in various manners.

According to an embodiment, if an input of swiping or dragging in the left and right directions in the lower area 1430 of the touchscreen 360 is identified, the electronic device 301 may display the execution screen of at least one application stored in the memory 350 other than the second execution screen 1411 of the second application, the portion 1413 of the third execution screen of the third application, and the fourth execution screen 1412 of the fourth application.

According to an embodiment, if a touch input or a tap input on the second execution screen 1411 is identified, the electronic device 301 may increase the size of the second execution screen 1411 and display the same on the touchscreen 360. In this case, the aspect ratio of the second execution screen displayed by increasing the size of the second execution screen 1411 may be the same as the aspect ratio of the second execution screen 1411. According to an embodiment, if a touch input or a tap input on the fourth execution screen 1414 is identified, the electronic device 301 may increase the size of the fourth execution screen 1414 and display the same in the display area of the touchscreen 360. In this case, the aspect ratio of the fourth execution screen displayed by increasing the size of the fourth execution screen 1414 may be the same as the aspect ratio of the fourth execution screen 1414.

According to an embodiment, the electronic device 301 may display an object 1431 capable of displaying a home screen. According to an embodiment, if an input on the object 1431 capable of displaying the home screen is identified, the electronic device 301 may display the home screen of the electronic device 301 illustrated in FIG. 14D on the touchscreen 360. The input on the object 1431 capable of displaying the home screen may include an input of swiping from bottom to top. According to an embodiment, when the movement distance of the object 1431 according to the input on the object 1431 capable of displaying the home screen is larger than a preset distance, the electronic device 301 may display the home screen on the touchscreen 360. According to an embodiment, when the movement speed of the object 1431 according to the input on the object 1431 is larger than a preset speed, the electronic device 301 may display the home screen on the touchscreen 360.

FIG. 14C is a diagram illustrating an example operation in which an electronic device displays an execution screen of at least one application based on an input on a first execution screen according to various embodiments.

Referring to FIGS. 14B and 14C, according to an embodiment, the electronic device 301 (e.g., the electronic device 301 of FIG. 3) may display the second execution screen 1421, the third execution screen 1423, the fourth execution screen 1422, and the fifth execution screen 1425 on the first execution screen 1410 on the touchscreen 360 if an input of swiping or dragging an object (1432 of FIG. 14B) displayed in the lower area 1430 of the touchscreen 360 (e.g., the touchscreen 360 of FIG. 3) from bottom to top is identified. According to an embodiment, the object (1432 of FIG. 14B) may be displayed at the upper end of the lower area 1430 of the touchscreen 360. However, this is an example, and the position where the object 1432 is displayed may not be limited thereto.

According to an embodiment, the electronic device 301 may adjust the transparency of, and display, portions of the first execution screen 1410 overlapping the second execution screen 1421, the third execution screen 1423, the fourth execution screen 1422, and the fifth execution screen 1425 on the first execution screen 1410.

According to an embodiment, if a touch input or a tap input on any one of the second execution screen 1421, the third execution screen 1423, the fourth execution screen 1422, and the fifth execution screen 1425 is identified, the electronic device 301 may increase the size of any one screen and display the same.

According to an embodiment, the electronic device 301 may display an object 1433 capable of displaying a home screen. According to an embodiment, if an input on the object 1433 capable of displaying the home screen is identified, the electronic device 301 may display the home screen of the electronic device 301 illustrated in FIG. 14D on the touchscreen 360. The input on the object 1433 capable of displaying the home screen may include an input of swiping from bottom to top.

According to an embodiment, when the movement distance of the object 1433 according to the input on the object 1433 capable of displaying the home screen is larger than a preset distance, the electronic device 301 may display the home screen on the touchscreen 360. According to an embodiment, when the movement speed of the object 1433 according to the input on the object 1433 is larger than a preset speed, the electronic device 301 may display the home screen on the touchscreen 360.

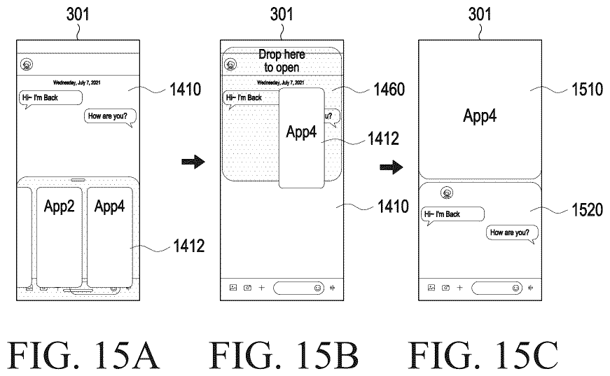

FIGS. 15A, 15B and 15C are diagrams illustrating an example operation in which an electronic device adjusts a display area of a screen displayed on a touchscreen according to various embodiments.

Referring to FIG. 15A, according to an embodiment, the electronic device 301 (e.g., the electronic device 301 of FIG. 3) may display the fourth execution screen 1412 on the first execution screen 1410. According to an embodiment, the electronic device 301 may apply a visual effect to the first execution screen 1410 so that the first execution screen 1410 is visually distinguished. For example, the electronic device 301 may adjust the transparency of the first execution screen 1410.

Referring to FIG. 15B, according to an embodiment, the electronic device 301 may identify an input for moving the fourth execution screen 1412 to the upper area 1460 of the touchscreen 360. For example, the input may include a drag input. According to an embodiment, the electronic device 301 may apply a visual effect to the upper area 1460 of the touchscreen 360 so that the upper area 1460 of the touchscreen 360 is visually distinguished from the first execution screen 1410.

Referring to FIG. 15C, according to an embodiment, if it is identified that the fourth execution screen 1412 is positioned in the upper area 1460 of the touchscreen 360 based on the drag input, the electronic device 301 may display a portion 1510 of the fourth execution screen and a portion 1520 of the first execution screen as split screens. According to an embodiment, the electronic device 301 may display the portion 1510 of the fourth execution screen in the upper area 1460 of the touchscreen 360, and display the portion 1520 of the first execution screen in the lower area of the touchscreen 360.

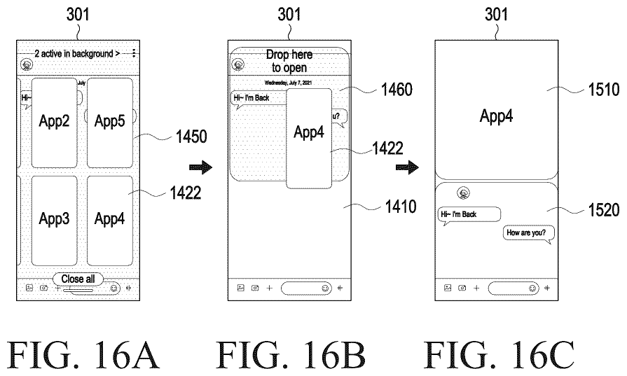

FIGS. 16A, 16B and 16C are diagrams illustrating an example operation in which an electronic device adjusts a display area of a screen displayed on a touchscreen according to various embodiments.

Referring to FIG. 16A, according to an embodiment, the electronic device 301 (e.g., the electronic device 301 of FIG. 3) may display the fourth execution screen 1422 on the first execution screen 1410. According to an embodiment, the electronic device 301 may apply a visual effect to the first execution screen 1410 so that the first execution screen 1410 is visually distinguished. For example, the electronic device 301 may adjust the transparency of the first execution screen 1410.

Referring to FIG. 16B, according to an embodiment, the electronic device 301 may identify an input for moving the fourth execution screen 1422 to the upper area 1460 of the touchscreen 360. For example, the input may include a drag input. According to an embodiment, the electronic device 301 may apply a visual effect to the upper area 1460 of the touchscreen 360 so that the upper area 1460 of the touchscreen 360 is visually distinguished from the first execution screen 1410.

Referring to FIG. 16C, according to an embodiment, if it is identified that the fourth execution screen 1412 is positioned in the upper area 1460 of the touchscreen 360 based on the drag input, the electronic device 301 may display a portion 1510 of the fourth execution screen and a portion 1520 of the first execution screen as split screens. According to an embodiment, the electronic device 301 may display the portion 1510 of the fourth execution screen in the upper area 1460 of the touchscreen 360, and display the portion 1520 of the first execution screen in the lower area of the touchscreen 360.

According to an embodiment, an electronic device 301 may comprise memory 350 storing instructions, a touchscreen 360, and a processor 320.

In the electronic device 301 according to an embodiment, the instructions may, when executed by the processor 320, cause the electronic device 301 to display a first execution screen of a first application on the touchscreen 360.

In the electronic device 301 according to an embodiment, the instructions may, when executed by the processor 320, cause the electronic device 301 to upon identifying a first input on a first object representing a second application included in the first execution screen, display a second execution screen of the second application and a portion of the first execution screen on the touchscreen 360.

In the electronic device 301 according to an embodiment, a second object for adjusting a display area of the first execution screen and the second execution screen may be displayed on the portion of the first execution screen or the second execution screen.

In the electronic device 301 according to an embodiment, the instructions may, when executed by the processor 320, cause the electronic device 301 to identify a second input on the second object through the touchscreen 360.

In the electronic device 301 according to an embodiment, the instructions may, when executed by the processor 320, cause the electronic device 301 to, based on a movement distance and movement direction of the second object according to the second input, display the first execution screen, the second execution screen, or a portion of the first execution screen and a portion of the second execution screen.

In the electronic device 301 according to an embodiment, the instructions may, when executed by the processor 320, cause the electronic device 301 to identify the movement distance of the second object based on the second input on the second object.

In the electronic device 301 according to an embodiment, the instructions may, when executed by the processor 320, cause the electronic device 301 to, if the movement distance of the second object according to the second input is identified to be larger than a designated first distance, display the portion of the first execution screen and the portion of the second execution screen as a split screen on the touchscreen 360.

In the electronic device 301 according to an embodiment, the portion of the first execution screen may include the first object.

In the electronic device 301 according to an embodiment, the instructions may, when executed by the processor 320, cause the electronic device 301 to display the first object to be visually distinguished.

In the electronic device 301 according to an embodiment, the instructions may, when executed by the processor 320, cause the electronic device 301 to, if the movement distance of the second object according to the second input is identified not to be larger than the first distance, display the second execution screen of the second application and the portion of the first execution screen.

In the electronic device 301 according to an embodiment, the instructions may, when executed by the processor 320, cause the electronic device 301 to, if the movement distance of the second object is identified to be larger than a designated second distance larger than the first distance, display the first execution screen on the touchscreen 360.

In the electronic device 301 according to an embodiment, the second input on the second object may include an input for swiping or dragging the second object.

In the electronic device 301 according to an embodiment, the instructions may, when executed by the processor 320, cause the electronic device 301 to, upon identifying an input for swiping or dragging the second object in a first direction, display the first execution screen on the touchscreen 360.

In the electronic device 301 according to an embodiment, the instructions may, when executed by the processor 320, cause the electronic device 301 to display the portion of the first execution screen and the portion of the second execution screen together on the touchscreen 360.

In the electronic device 301 according to an embodiment, the instructions may, when executed by the processor 320, cause the electronic device 301 to, upon identifying an input for swiping or dragging the second object in a second direction opposite to the first direction, display the second execution screen on the touchscreen 360.

In the electronic device 301 according to an embodiment, the instructions may, when executed by the processor 320, cause the electronic device 301 to, upon identifying a third input on the portion of the first execution screen, display the first execution screen on the touchscreen 360.

In the electronic device 301 according to an embodiment, the portion of the first execution screen may include an upper area or a lower area of the first execution screen.

In the electronic device 301 according to an embodiment, the instructions may, when executed by the processor 320, cause the electronic device 301 to, upon identifying the second input on the second object, apply a visual effect to the second object.

In the electronic device 301 according to an embodiment, the instructions may, when executed by the processor 320, cause the electronic device 301 to, upon identifying a fourth input on a third object representing a third application included in the second execution screen, display the portion of the first execution screen, a portion of the second execution screen, and a third execution screen of the third application on the touchscreen 360.

According to an embodiment, a method for operating an electronic device 301 may comprise displaying a first execution screen of a first application on a touchscreen 360 of the electronic device 301.

According to an embodiment, the method for operating the electronic device 301 may comprise, upon identifying an input on a first object representing a second application included in the first execution screen, displaying a second execution screen of the second application and a portion of the first execution screen on the touchscreen.

According to an embodiment, in the method for operating the electronic device 301, a second object for adjusting a display area of the first execution screen and the second execution screen may be displayed on the portion of the first execution screen or the second execution screen.

According to an embodiment, the method for operating the electronic device 301 may comprise identifying an input on the second object through the touchscreen.

According to an embodiment, the method for operating the electronic device 301 may comprise, based on a movement distance and movement direction of the second object according to the second input, displaying the first execution screen, the second execution screen, or a portion of the first execution screen and a portion of the second execution screen.

According to an embodiment, the method for operating the electronic device 301 may comprise identifying the movement distance of the second object based on the second input on the second object.

According to an embodiment, the method for operating the electronic device 301 may comprise, if the movement distance of the second object according to the second input is identified to be larger than a designated first distance, displaying the portion of the first execution screen and the portion of the second execution screen as a split screen on the touchscreen 360.

In the method for operating the electronic device 301 according to an embodiment, the portion of the first execution screen may include the first object.

According to an embodiment, the method for operating the electronic device 301 may comprise displaying the first object to be visually distinguished.

According to an embodiment, the method for operating the electronic device 301 may comprise, if the movement distance of the second object according to the second input is identified not to be larger than the first distance, displaying the second execution screen of the second application and the portion of the first execution screen.

According to an embodiment, the method for operating the electronic device 301 may comprise, if the movement distance of the second object is identified to be larger than a designated second distance larger than the first distance, displaying the first execution screen on the touchscreen 360.

In the method for operating the electronic device 301 according to an embodiment, the second input on the second object may include an input for swiping or dragging the second object.

According to an embodiment, the method for operating the electronic device 301 may comprise, upon identifying an input for swiping or dragging the second object in a first direction, displaying the first execution screen on the touchscreen 360 or displaying the portion of the first execution screen and the portion of the second execution screen together on the touchscreen.

According to an embodiment, the method for operating the electronic device 301 may comprise, upon identifying an input for swiping or dragging the second object in a second direction opposite to the first direction, displaying the second execution screen on the touchscreen 360.

According to an embodiment, the method for operating the electronic device 301 may comprise, upon identifying a third input on the portion of the first execution screen, displaying the first execution screen on the touchscreen 360.

According to an embodiment, in the method for operating the electronic device 301, the portion of the first execution screen may include an upper area or a lower area of the first execution screen.

According to an embodiment, a non-transitory storage medium may store at least one instruction capable of executing displaying a first execution screen of a first application on a touchscreen 360 of an electronic device 301.

According to an embodiment, the non-transitory recording medium may store at least one instruction capable of executing, upon identifying an input on a first object representing a second application included in the first execution screen, displaying a second execution screen of the second application and a portion of the first execution screen on the touchscreen 360.

According to an embodiment, in the non-transitory storage medium, a second object for adjusting a display area of the first execution screen and the second execution screen may be displayed on the portion of the first execution screen or the second execution screen.

According to an embodiment, the non-transitory recording medium may store at least one instruction capable of executing identifying an input on the second object through the touchscreen 360.

According to an embodiment, the non-transitory recording medium may store at least one instruction capable of executing, based on a movement distance and movement direction of the second object according to the second input, displaying the first execution screen, the second execution screen, or a portion of the first execution screen and a portion of the second execution screen.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101 or the electronic device 301). For example, a processor (e.g., the processor 120 or processor 320) of the machine (e.g., the electronic device 101 or electronic device 301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device, comprising:
a touchscreen;
memory storing instructions; and
at least one processor, comprising processing circuitry, wherein at least one processor, individually and/or collectively, is configured to execute the instructions and to cause the electronic device to:
display a first execution screen of a first application on the touchscreen;
based on identifying a first input on a first object representing a second application included in the first execution screen, display, on the touchscreen, a second execution screen of the second application and a portion of the first execution screen, wherein a second object for adjusting a display area of the first execution screen and the second execution screen is displayed on the portion of the first execution screen or the second execution screen;
identify a second input on the second object through the touchscreen; and
based on a movement distance and movement direction of the second object according to the second input, display the first execution screen, the second execution screen, or a portion of the first execution screen and a portion of the second execution screen.

2. The electronic device of claim 1, wherein at least one processor, individually and/or collectively, is configured to cause the electronic device to:
identify the movement distance of the second object based on the second input on the second object; and
based on the movement distance of the second object according to the second input being identified to be greater than a designated first distance, display, on the touchscreen, the portion of the first execution screen and the portion of the second execution screen as a split screen.

3. The electronic device of claim 1, wherein the portion of the first execution screen includes the first object, and wherein at least one processor, individually and/or collectively, is configured to cause the electronic device to display the first object to be visually distinguished.

4. The electronic device of claim 1, wherein at least one processor, individually and/or collectively, is configured to cause the electronic device to:
based on the movement distance of the second object according to the second input being identified to not be greater than the first distance, display the second execution screen and the portion of the first execution screen.

5. The electronic device of claim 1, wherein at least one processor, individually and/or collectively, is configured to cause the electronic device to:
based on the movement distance of the second object being identified to be greater than a designated second distance greater than the first distance, display, on the touchscreen, the first execution screen.

6. The electronic device of claim 1, wherein the second input on the second object includes an input for swiping or dragging the second object.

7. The electronic device of claim 1, wherein at least one processor, individually and/or collectively, is configured to cause the electronic device to:
based on identifying an input for swiping or dragging the second object in a first direction, display, on the touchscreen, the first execution screen or display, on the touchscreen, the portion of the first execution screen and the portion of the second execution screen together; and
based on identifying an input for swiping or dragging the second object in a second direction opposite to the first direction, display, on the touchscreen, the second execution screen.

8. The electronic device of claim 1, wherein at least one processor, individually and/or collectively, is configured to cause the electronic device to:
based on identifying a third input on the portion of the first execution screen, display, on the touchscreen, the first execution screen.

9. The electronic device of claim 1, wherein the portion of the first execution screen includes an upper area or a lower area of the first execution screen.

10. The electronic device of claim 1, wherein at least one processor, individually and/or collectively, is configured to cause the electronic device to:
based on identifying the second input on the second object, apply a visual effect to the second object.

11. The electronic device of claim 8, wherein at least one processor, individually and/or collectively, is configured to cause the electronic device to:
based on identifying a fourth input on a third object representing a third application included in the second execution screen, display, on the touchscreen, the portion of the first execution screen, a portion of the second execution screen, and a third execution screen of the third application.

12. A method for operating an electronic device, the method comprising:
displaying, on a touchscreen of the electronic device, a first execution screen of a first application;
based on identifying an input on a first object representing a second application included in the first execution screen, displaying, on the touchscreen, a second execution screen of the second application and a portion of the first execution screen, wherein a second object for adjusting a display area of the first execution screen and the second execution screen is displayed on the portion of the first execution screen or the second execution screen;
identifying an input on the second object through the touchscreen; and
based on a movement distance and movement direction of the second object according to the second input, displaying the first execution screen, the second execution screen, or a portion of the first execution screen and a portion of the second execution screen.

13. The method of claim 12, wherein at least part of, based on a movement distance and movement direction of the second object according to the second input, displaying the portion of the first execution screen and the portion of the second execution screen includes:
identifying the movement distance of the second object based on the second input on the second object; and
based on the movement distance of the second object according to the second input being identified to be greater than a designated first distance, displaying, on the touchscreen, the portion of the first execution screen and the portion of the second execution screen as a split screen.

14. The method of claim 12, wherein the portion of the first execution screen includes the first object, and wherein the method further comprises displaying the first object to be visually distinguished.

15. A non-transitory computer-readable storage medium, storing at least one instruction which, when executed by at least one processor, comprising processing circuitry, individually and/or collectively, of an electronic device, cause the electronic device to perform operations comprising:
displaying, on a touchscreen of an electronic device, a first execution screen of a first application;
based on identifying an input on a first object representing a second application included in the first execution screen, displaying, on the touchscreen, a second execution screen of the second application and a portion of the first execution screen, wherein a second object for adjusting a display area of the first execution screen and the second execution screen is displayed on the portion of the first execution screen or the second execution screen;
identifying an input on the second object through the touchscreen; and
based on a movement distance and movement direction of the second object according to the second input, displaying the first execution screen, the second execution screen, or a portion of the first execution screen and a portion of the second execution screen.
